(19) United States
(12) Patent Application Publication
(10) Pub. No.: US 2015/0255828 A1
(43) Pub. Date: Sep. 10, 2015

(54) SECONDARY BATTERY

(71) Applicant: SEMICONDUCTOR ENERGY LABORATORY CO., LTD., Atsugi-shi (JP)

(72) Inventors: Junpei MOMO, Sagamihara (JP); Nobuhiro INOUE, Isehara (JP); Takahiro KAWAKAMI, Atsugi (JP); Yohei MOMMA, Isehara (JP)

(21) Appl. No.: 14/636,930

(22) Filed: Mar. 3, 2015

(30) Foreign Application Priority Data
Mar. 7, 2014 (JP) 2014-045546

(51) Int. Cl. H01M 10/052; H01M 4/38; H01M 10/0585; H01M 4/583

(52) U.S. Cl. CPC H01M 10/052; H01M 4/583; H01M 4/386; H01M 4/382; H01M 10/0585; H01M 2220/30

(57) ABSTRACT

To provide a lithium-ion secondary battery including a first electrode including a first electrode active substance and a second electrode including a second electrode active substance and a third electrode active substance. The second electrode active substance has higher charge and discharge efficiency than the first electrode active substance. The third electrode active substance has lower charge and discharge efficiency than the second electrode active substance. The product of the capacity of the second electrode active substance and the difference between the charge and discharge efficiency of the second electrode active substance and charge and discharge efficiency of the first electrode active substance is greater than the product of the capacity of the third electrode active substance and the difference between the charge and discharge efficiency of the first electrode active substance and the charge and discharge efficiency of the third electrode active substance. The compounding proportion of the second electrode active substance in the total of the second electrode active substance and the third electrode active substance is less than the compounding proportion of the third electrode active substance in the total of the second electrode active substance and the third electrode active substance.

### BACKGROUND OF THE INVENTION

1. Field of the Invention

One embodiment of the present invention relates to a lithium-ion secondary battery and a method of manufacturing the lithium-ion secondary battery.

Note that one embodiment of the present invention is not limited to the above technical field. The technical field of one embodiment of the invention disclosed in this specification and the like relates to an object, a method, or a manufacturing method. In addition, one embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a storage device, a method of driving any of them, and a method of manufacturing any of them.

2. Description of the Related Art

Examples of secondary batteries include a nickel-metal hydride battery, a lead secondary battery, and a lithium-ion secondary battery.

Such secondary batteries are used as power sources in portable information terminals typified by mobile phones. In particular, lithium-ion secondary batteries have been actively researched and developed because capacity thereof can be increased and size thereof can be reduced.

A major challenge in developing lithium-ion secondary batteries is increasing capacity, which leads to a longer operating time and a lighter weight for mobile uses and to a longer driving distance for automobile uses. For example, a positive electrode active substance is an important factor determining the amount of the lithium ions contributing to a battery reaction. A negative electrode active substance is also an important factor since it needs to cause a reversible reaction with lithium ions whose amount is the same as in the positive electrode.

Examples of the known positive electrode active substance material of a lithium-ion secondary battery are phosphate compounds having an olivine structure and containing lithium and iron, manganese, cobalt, or nickel, such as lithium iron phosphate (LiFePO₄), lithium manganese phosphate (LiMnPO₄), lithium cobalt phosphate (LiCoPO₄), and lithium nickel phosphate (LiNiPO₄), which are disclosed in Patent Document 1, and the like. Examples of the negative electrode active substance material are, in addition to a graphite material, silicon, tin, and oxides thereof disclosed as high-capacity materials in Patent Document 2, for example.

### REFERENCES

### Patent Documents

[Patent Document 1] Japanese Published Patent Application No. H11-25983
[Patent Document 2] Japanese Published Patent Application No. 2007-106634

### SUMMARY OF THE INVENTION

The standard electrode potential (equilibrium potential) of lithium is as very low as −3.045 V (vs. SHE) to the degree that, for example, many organic solvents are reduced and decomposed in a negative electrode. However, in the case of some organic solvents, reductive decomposition allows a decomposition product to collect on a surface and form a film, which inhibits further decomposition of the organic solvent. As the film is being formed, the decomposition reaction of the electrolyte solution, which is an irreversible reaction, is inhibited compared with a reaction of lithium ions, which is a reversible reaction. Thus, mainly during the initial charge and discharge, an irreversible reaction occurs and causes movement of electric charge, the amount of which equals the sum of those in the reversible reaction and the irreversible reaction.

During the initial charge, in addition to the reversible reaction due to release of lithium ions from the positive electrode, the irreversible reaction occurs and the amount of moving electric charge increases accordingly. The amount of moving electric charge involved in the irreversible reaction is referred to as irreversible capacity, and the amount of moving electric charge involved in the reversible reaction is referred to as reversible capacity. They collectively correspond to initial charge capacity.

In contrast, during the initial discharge, although the reversible chemical reaction between lithium ions and the positive electrode occurs and causes movement of electric charge, movement of electric charge involved in the irreversible reaction does not occur. That is, the reversible capacity is the discharge capacity. Here, the ratio of the discharge capacity to the charge capacity is referred to as charge and discharge efficiency. Higher irreversible capacity means lower charge and discharge efficiency.

A material of a positive electrode active substance is a factor determining the irreversible capacity of the positive electrode. The positive electrode active substance material preferably has low irreversible capacity and high charge and discharge efficiency.

However, in many cases, as the positive electrode active substance material has better cycle characteristics and higher capacity, its irreversible capacity is relatively higher and its charge and discharge efficiency is relatively lower. If a material having low charge and discharge efficiency is used as the positive electrode active substance material, movement of electric charge corresponding to irreversible capacity in addition to reversible capacity occurs during the initial charge. Here, in a battery reaction, the amount of electric charge in a positive electrode reaction is equal to the amount of electric charge in a negative electrode reaction. Hence, in the negative electrode, a larger amount of negative electrode active substance material is needed because of the electric charge corresponding to the irreversible capacity in addition to the reversible capacity. This increases the mass and volume of the negative electrode, leading to lower battery capacity per unit mass and volume. Additionally, the increased amount of negative electrode active substance material does not contribute to a battery reaction during and after the second charge and discharge; this is wasteful of the material.

The same applies to the negative electrode. A high-capacity negative electrode active substance material has relatively high irreversible capacity and low charge and discharge efficiency in many cases. Hence, in the case where a high-capacity negative electrode active substance material is used as the negative electrode of a secondary battery, an extra amount of positive electrode active substance material corresponding to the irreversible capacity is needed, since the amount of electric charge in a negative electrode reaction is equal to the amount of electric charge in a positive electrode reaction. This increases the mass and volume of the positive electrode, leading to lower battery capacity per unit mass and volume. The increased amount of positive electrode active substance material does not contribute to a battery reaction; this is wasteful of the material.

An object of one embodiment of the present invention is to provide a secondary battery with high capacity per unit mass and volume. Another object is to provide a secondary battery using an electrode active substance material without waste thereof. Another object is to provide an electrode active substance in which material compounding proportions are appropriate. Another object is to provide a method of manufacturing a secondary battery by determining appropriate compounding proportions in an electrode active substance. An object of one embodiment of the present invention is to provide a method of manufacturing a secondary battery with high capacity per unit mass and volume. Another object of one embodiment of the present invention is to provide a novel secondary battery, a novel power storage device, a novel method of manufacturing a secondary battery, or a novel method of manufacturing a power storage device.

Note that the description of these objects does not disturb the existence of other objects. In one embodiment of the present invention, there is no need to achieve all the objects. Other objects will be apparent from and can be derived from the description of the specification, the drawings, the claims, and the like.

One embodiment of the present invention is a lithium-ion secondary battery including a first electrode and a second electrode, the first electrode includes a first electrode active substance, and the second electrode includes a second electrode active substance and a third electrode active substance. Charge and discharge efficiency of the second electrode active substance is different from charge and discharge efficiency of the third electrode active substance.

Another embodiment of the present invention is a lithium-ion secondary battery including a first electrode and a second electrode, the first electrode includes a first electrode active substance, and the second electrode includes a second electrode active substance and a third electrode active substance. The second electrode active substance has higher charge and discharge efficiency than the first electrode active substance. The third electrode active substance has lower charge and discharge efficiency than the second electrode active substance.

Another embodiment of the present invention is a lithium-ion secondary battery including a first electrode and a second electrode, the first electrode includes a first electrode active substance, and the second electrode includes a second electrode active substance and a third electrode active substance. The second electrode active substance has higher charge and discharge efficiency than the first electrode active substance. The third electrode active substance has lower charge and discharge efficiency than the second electrode active substance. A product of capacity of the second electrode active substance and a difference between charge and discharge efficiency of the second electrode active substance and charge and discharge efficiency of the first electrode active substance is greater than a product of capacity of the third electrode active substance and a difference between the charge and discharge efficiency of the first electrode active substance and the charge and discharge efficiency of the third electrode active substance. A compounding proportion of the second electrode active substance in a total of the second electrode active substance and the third electrode active substance is less than a compounding proportion of the third electrode active substance in the total of the second electrode active substance and the third electrode active substance.

Another embodiment of the present invention is a lithium-ion secondary battery including a first electrode and a second electrode, the first electrode includes a first electrode active substance, and the second electrode includes a second electrode active substance and a third electrode active substance. The second electrode active substance has higher charge and discharge efficiency than the first electrode active substance. The third electrode active substance has lower charge and discharge efficiency than the second electrode active substance. A product of capacity of the second electrode active substance and a difference between charge and discharge efficiency of the second electrode active substance and charge and discharge efficiency of the first electrode active substance is less than a product of capacity of the third electrode active substance and a difference between the charge and discharge efficiency of the first electrode active substance and the charge and discharge efficiency of the third electrode active substance. A compounding proportion of the second electrode active substance in a total of the second electrode active substance and the third electrode active substance is greater than a compounding proportion of the third electrode active substance in the total of the second electrode active substance and the third electrode active substance.

Another embodiment of the present invention is a secondary battery including a first electrode including a first electrode active substance and a second electrode including a second electrode active substance and a third electrode active substance. A compounding proportion of the second electrode active substance in a total of the second electrode active substance and the third electrode active substance satisfies an equation (1).

$${R}_{2} = \frac{{Q}_{3} ( {E}_{1} - {E}_{3} )}{{Q}_{2} ( {E}_{2} - {E}_{1} ) + {Q}_{3} ( {E}_{1} - {E}_{3} )} \qquad ( 1 )$$

In the equation (1), R₂ represents the compounding proportion of the second electrode active substance; E₁ represents charge and discharge efficiency of the first electrode active substance; Q₂ represents capacity of the second electrode active substance; E₂ represents charge and discharge efficiency of the second electrode active substance; Q₃ represents capacity of the third electrode active substance; and E₃ represents charge and discharge efficiency of the third electrode active substance.

In one embodiment of the present invention, the first electrode may be a positive electrode and the second electrode may be a negative electrode. In addition, the second electrode active substance may include carbon and the third electrode active substance may include silicon and oxygen.

When a high-capacity secondary battery is manufactured using a positive electrode active substance material having relatively low charge and discharge efficiency and a negative electrode active substance material having relatively low charge and discharge efficiency, a problem caused by irreversible capacity can be canceled and a reduction in battery capacity per unit mass and volume can be suppressed. Consequently, the electrode active substance materials can be used without being wasted.

For example, the problem caused by irreversible capacity can be canceled as follows. When the charge and discharge efficiency of a positive electrode active substance material is relatively higher than that of a negative electrode active substance material, an increased amount of moving electric charge during the initial charge due to the irreversible capacity of the positive electrode active substance material is covered by an increased amount of moving electric charge due to the irreversible capacity of the negative electrode active substance material. Therefore, an increase in the positive electrode active substance material by an amount corresponding to the covered electric charge is not needed, and thus an increase in the mass and volume of the battery can be suppressed. This can also reduce a wasteful positive electrode active substance material. Consequently, the battery capacity per unit mass and volume can be increased.

Also when the charge and discharge efficiency of the negative electrode active substance material is relatively higher than that of the positive electrode active substance material, there is no need to increase the amount of the negative electrode active substance material corresponding to the irreversible capacity of the negative electrode active substance material. This can reduce an increase in the mass and volume of the battery and also reduce a wasteful positive electrode active substance material. Consequently, the battery capacity per unit mass and volume can be increased.

If the charge and discharge efficiency of the positive electrode active substance material and that of the negative electrode active substance material can be close to each other, the above-described cancellation effect can be enhanced, so that battery capacity per unit mass and volume can be increased and a waste of the electrode active substance materials can be prevented. However, there is limitation on the substances that can be selected as the electrode active substance materials and a combination of a positive electrode active substance material and a negative electrode active substance material needs to be selected so as to meet other various requirements.

To use electrode active substance materials with a good balance for a secondary battery, preferably, two or more different kinds of electrode active substance materials are prepared for one electrode, and the compounding amounts are determined so that its charge and discharge efficiency can be suitably combined with the charge and discharge efficiency of the electrode active substance material of the other electrode. For example, in the case of using two kinds of negative electrode active substance materials, a negative electrode active substance material having higher charge and discharge efficiency than the positive electrode active substance material, and a negative electrode active substance material having lower charge and discharge efficiency than the positive electrode active substance material are compounded and used as a negative electrode active substance; consequently, the charge and discharge efficiency of the positive electrode and that of the negative electrode can be close to each other. Furthermore, when the amount of one of the two kinds of negative electrode active substance materials having charge and discharge efficiency closer to that of the positive electrode active substance material is larger than the amount of the other negative electrode active substance material, the charge and discharge efficiency of the compounded negative electrode active substance can further be close to that of the positive electrode active substance material. Alternatively, two or more kinds of positive electrode active substance materials may be used in a similar manner, or two or more kinds of materials may be used as the active substance materials of each electrode.

The compounding proportions of electrode active substance materials may be determined by calculation so that the charge and discharge efficiency of the positive electrode and that of the negative electrode can be equal to each other to manufacture a high-capacity secondary battery without a waste of an active substance material.

According to one embodiment of the present invention, an electrode active substance material having relatively low charge and discharge efficiency can be used while suppressing a reduction in battery capacity. Since the electrode active substance material having relatively low charge and discharge efficiency usually has high capacity originally, use of such a material can further increase battery capacity.

According to one embodiment of the present invention, a secondary battery with high capacity per unit mass and volume can be provided. A secondary battery using an electrode active substance material without waste thereof can be provided. An electrode active substance in which material compounding proportions are appropriate can be provided. A method of manufacturing a secondary battery by determining appropriate compounding proportions in an electrode active substance can be provided. According to one embodiment of the present invention, a method of manufacturing a secondary battery with high capacity per unit mass and volume can be provided. Alternatively, according to one embodiment of the present invention, a novel secondary battery, a novel power storage device, a novel method of manufacturing a secondary battery, or a novel method of manufacturing a power storage device can be provided.

Note that the description of these effects does not disturb the existence of other effects. One embodiment of the present invention does not necessarily achieve all the effects listed above. Other effects will be apparent from and can be derived from the description of the specification, the drawings, the claims, and the like.

### BRIEF DESCRIPTION OF THE DRAWINGS

In the accompanying drawings:

FIGS. 1A and 1B illustrate a secondary battery according to one embodiment of the present invention;

FIGS. 2A to 2D are drawings for explaining the radius of curvature;

FIGS. 3A to 3C are drawings for explaining the radius of curvature;

FIGS. 4A to 4D illustrate electronic appliances on each of which a secondary battery according to one embodiment of the present invention is mounted;

FIGS. 5A to 5C illustrate an electronic appliance on which a secondary battery according to one embodiment of the present invention is mounted;

FIG. 6 illustrates a side view of the electronic appliance on which a secondary battery according to one embodiment of the present invention is mounted;

FIG. 7 shows X-ray diffraction (XRD) measurement results of a lithium-manganese composite oxide;

FIG. 8 shows charge and discharge characteristics of a half-cell;

FIG. 9 shows charge and discharge characteristics of a coin cell;

FIG. 10 shows charge and discharge characteristics of a half-cell; and

FIGS. 11A and 11B show charge and discharge characteristics of secondary batteries.

### DETAILED DESCRIPTION OF THE INVENTION

Embodiments of the present invention will be described below in detail with reference to the drawings. However, the present invention is not limited to the description below, and it is easily understood by those skilled in the art that modes and details disclosed herein can be modified in various ways. Further, the present invention is not construed as being limited to description of the embodiments.

Note that in each drawing described in this specification, the size of each component, such as the thickness and the size of a positive electrode, a negative electrode, an active substance layer, a separator, an exterior body, and the like is exaggerated for clarity in some cases. Therefore, the sizes of the components are not limited to the sizes in the drawings and relative sizes between the components.

Ordinal numbers such as “first”, “second”, and “third” are used for convenience and do not denote the order of steps or the stacking order of layers. Therefore, for example, description can be made even when “first” is replaced with “second”, “third”, or the like as appropriate. In addition, the ordinal numbers in this specification and the like are not necessarily the same as those which specify one embodiment of the present invention.

Note that in the structures of one embodiment of the present invention described in this specification and the like, the same portions or portions having similar functions in different drawings are denoted by the same reference numerals, and description of such portions is not repeated. Further, the same hatching pattern is applied to portions having similar functions, and the portions are not especially denoted by reference numerals in some cases.

The descriptions in embodiments for the present invention can be combined with each other as appropriate.

### Embodiment 1

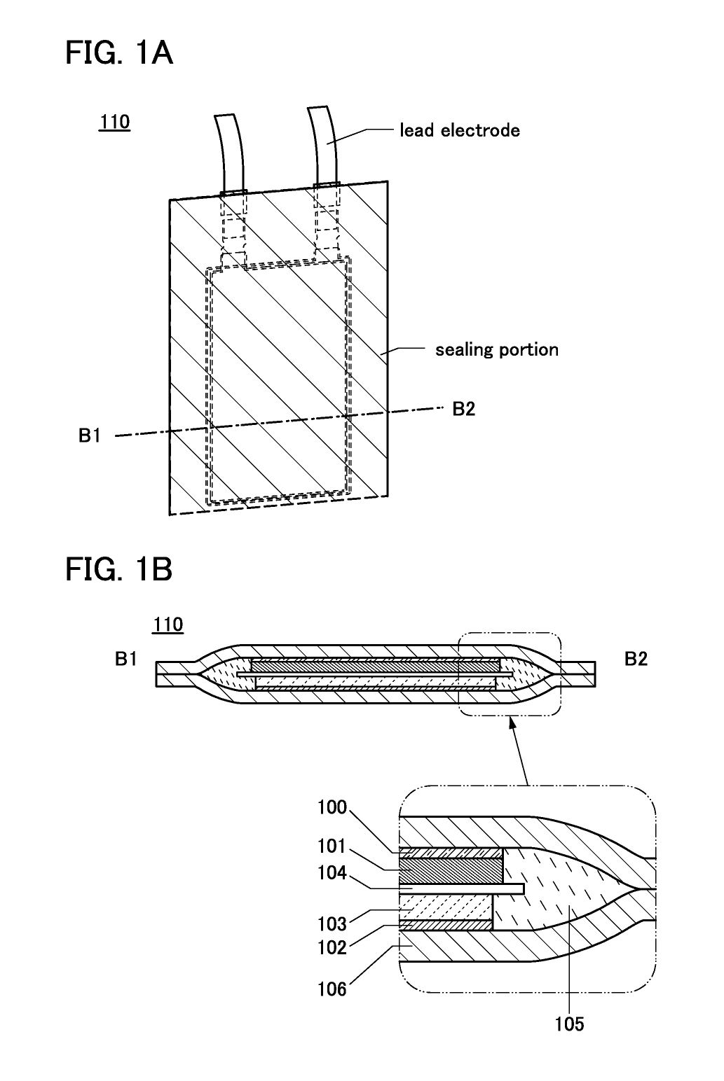

A method of manufacturing a lithium-ion secondary battery 110 according to one embodiment of the present invention is described using FIGS. 1A and 1B. FIG. 1B is a cross-sectional view of the lithium-ion secondary battery 110. In the schematic cross-sectional view, a positive electrode current collector 100, a positive electrode active substance layer 101, a separator 104, a negative electrode active substance layer 103, and a negative electrode current collector 102 are stacked and, together with an electrolyte solution 105, enclosed by an exterior body 106. Note that the active substance layers can be formed on both surfaces of the current collector, and the secondary battery can have a stacked-layer structure.

The positive electrode is described. The positive electrode includes at least the positive electrode active substance layer 101 and the positive electrode current collector 100. In this embodiment, steps of forming the positive electrode with the use of lithium iron phosphate (LiFePO₄) as a material used for the positive electrode active substance layer 101 are described below.

As the positive electrode active substance, a material into and from which carrier ions such as lithium ions can be inserted and extracted can be used. Examples of the material are a lithium-containing material with an olivine crystal structure, a layered rock-salt crystal structure, a spinel crystal structure, and the like.

Typical examples of the lithium-containing material with an olivine crystal structure (general formula: LiMPO₄ (M is Fe(II), Mn(II), Co(II), or Ni(II))), are LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b 1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e 1, 0<c<1, 0<d<1, and 0<e<1), LiFe_{f}Ni_{g}CoₕMnᵢPO₄ (f+g+h+i1, 0<f<1, 0<g<1, 0<h<1, and 0<i<1), and the like.

For example, lithium iron phosphate (LiFePO₄) is particularly preferable because it properly has properties necessary for the positive electrode active substance, such as safety, stability, high capacity density, high potential, and the existence of lithium ions that can be extracted in initial oxidation (charge).

Examples of the lithium-containing material with a layered rock-salt crystal structure include lithium cobalt oxide (LiCoO₂); LiNiO₂; LiMnO₂; Li₂MnO₃; an NiCo-based lithium-containing material (general formula: LiNiₓCo₁₋ₓO₂ (0<x<1)) such as LiNi_{0.8}Co_{0.2}O₂; an NiMn-based lithium-containing material (general formula: LiNiₓMn₁₋ₓO₂ (0<x<1)) such as LiNi_{0.5}Mn_{0.5}O₂; and an NiMnCo-based lithium-containing material (also referred to as NMC, and general formula: LiNiₓMn_{y}Co_{1-x-y}O₂ (x>0, y>0, x+y<1)) such as LiNi_{1/3}Mn_{1/3}Co_{1/3}O₂. Moreover, Li(Ni_{0.8}Co_{0.15}Al_{0.05})O₂, Li₂MnO₃—LiMO₂ (M is Co, Ni, or Mn), and the like can be given.

In particular, LiCoO₂ is preferable because it has high capacity, stability in the air higher than that of LiNiO₂, and thermal stability higher than that of LiNiO₂, for example.

Examples of the lithium-containing material with a spinel crystal structure are LiMn₂O₄, Li(MnAl)₂O₄, LiMn_{1.5}Ni_{0.5}O₄, and the like.

It is preferable to add a small amount of lithium nickel oxide (LiNiO₂ or LiNi₁₋ₓMO₂ (M=Co, Al, or the like)) to the lithium-containing material with a spinel crystal structure which contains manganese such as LiMn₂O₄, in which case the elution of manganese and the decomposition of an electrolyte solution can be suppressed, for example.

A composite oxide expressed by Li(₂₋ⱼ)MSiO₄ (general formula) (M is Fe(II), Mn(II), Co(II), or Ni(II), 0≦j≦2) can also be used as the positive electrode active substance. Typical examples of the general formula Li(₂₋ⱼ)MSiO₄ include Li(₂₋ⱼ)FeSiO₄, Li(₂₋ⱼ)NiSiO₄, Li(₂₋ⱼ)CoSiO₄, Li(₂₋ⱼ)MnSiO₄, Li(₂₋ⱼ)FeₖNiₗSiO₄, Li(₂₋ⱼ)FeₖCoₗSiO₄, Li(₂₋ⱼ)FeₖMnₗSiO₄, Li(₂₋ⱼ)NiₖCoₗSiO₄, Li(₂₋ⱼ)NiₖMnₗSiO₄ (k+l≦1, 0<k<1, and 0<l<1), Li(₂₋ⱼ)FeₘNiₙCo_{q}SiO₄, Li(₂₋ⱼ)FeₘNiₙMn_{q}SiO₄, Li(₂₋ⱼ)NiₘCoₙMn_{q}SiO₄ (m+n+q≦1, 0<m<1, 0<n<1, and 0<q<1), and Li(₂₋ⱼ)FeᵣNiₛCoₜMnᵤSiO₄ (r+s+t+u≦1, 0<r<1, 0<s<1, 0<t<1, and 0<u<1).

Alternatively, a nasicon compound represented by a general formula AₓM₂(XO₄)₃ (A is Li, Na, or Mg, M is Fe, Mn, Ti, V, Nb, or Al, and X is S, P, Mo, W, As, or Si), can be used as the positive electrode active substance. Examples of the nasicon compound are Fe₂(MnO₄)₃, Fe₂(SO₄)₃, Li₃Fe₂(PO₄)₃, and the like. Further alternatively, a compound represented by a general formula Li₂MPO₄F, Li₂MP₂O₇, or Li₅MO₄ (M is Fe or Mn), a perovskite fluoride such as NaF₃ or FeF₃, a metal chalcogenide (a sulfide, a selenide, or a telluride) such as TiS₂ or MoS₂, a lithium-containing material with an inverse spinel crystal structure such as LiMVO₄, a vanadium oxide (V₂O₅, V₆O₁₃, LiV₃O₈, or the like), a manganese oxide, an organic sulfur compound, or the like can be used as the positive electrode active substance.

In the case where carrier ions are alkali metal ions other than lithium ions, or alkaline-earth metal ions, the positive electrode active substance material may contain, instead of lithium in the compound and the oxide, an alkali metal (e.g., sodium or potassium), an alkaline-earth metal (e.g., calcium, strontium, barium, beryllium, or magnesium). For example, the positive electrode active substance material may be a layered oxide containing sodium such as NaFeO₂ or Na_{2/3}[Fe_{1/2}Mn_{1/2}]O₂.

Further alternatively, any of the aforementioned materials may be combined to be used as the positive electrode active substance. For example, a solid solution obtained by combining two or more of the above materials can be used as the positive electrode active substance. For example, a solid solution of LiCo_{1/3}Mn_{1/3}Ni_{1/3}O₂ and Li₂MnO₃ can be used as the positive electrode active substance.

The average particle diameter of the primary particle of the positive electrode active substance is preferably greater than or equal to 50 nm and less than or equal to 100 μm.

The material of the positive electrode active substance is a factor determining the irreversible capacity of the positive electrode. The positive electrode active substance material preferably has low irreversible capacity and high charge and discharge efficiency. However, as the positive electrode active substance material has better cycle characteristics and higher capacity, its irreversible capacity is relatively high and its charge and discharge efficiency is relatively low in many cases. As the charge and discharge efficiency of the positive electrode is lower, the necessary amount of negative electrode active substance material is larger and the battery increases in volume and mass; consequently, the battery capacity decreases. In other words, it is not easy to simply use a positive electrode active substance material having relatively low charge and discharge efficiency for a lithium-ion secondary battery. Accordingly, to use a positive electrode active substance material having relatively low charge and discharge efficiency, a negative electrode active substance material is examined. The details are described later.

Examples of the conductive additive include acetylene black (AB), graphite (black lead) particles, carbon nanotubes, graphene, and fullerene.

A network for electron conduction can be formed in the electrode by the conductive additive. The conductive additive also allows maintaining of a path for electric conduction between the particles of the positive electrode active substance.

The addition of the conductive additive to the positive electrode active substance layer increases the electron conductivity of the positive electrode active substance layer 101.

A typical example of the binder is polyvinylidene fluoride (PVDF), and other examples of the binder include polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, and nitrocellulose.

The content of the binder in the positive electrode active substance layer 101 is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %. The content of the conductive additive in the positive electrode active substance layer 101 is preferably greater than or equal to 1 wt % and less than or equal to 10 wt %, more preferably greater than or equal to 1 wt % and less than or equal to 5 wt %.

In the case where the positive electrode active substance layer 101 is formed by a coating method, the positive electrode active substance, the binder, the conductive additive, and a dispersion medium are mixed to form an electrode paste (slurry), and the electrode paste is applied to the positive electrode current collector 100 and dried. In this embodiment, a metal material including aluminum as its main component is preferably used as the positive electrode current collector 100.

The positive electrode current collector can be formed using a material, which has high conductivity and is not alloyed with carrier ions of lithium or the like, such as stainless steel, gold, platinum, aluminum, or titanium, or an alloy thereof. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The positive electrode current collector can have a foil shape, a plate (sheet) shape, a net shape, a punching-metal shape, an expanded-metal shape, or the like as appropriate.

Through the above steps, the positive electrode of the lithium-ion secondary battery can be fabricated.

Next, the negative electrode is described with reference to FIG. 1A. The negative electrode includes at least the negative electrode active substance layer 103 and the negative electrode current collector 102. Steps of forming the negative electrode are described below.

Examples of the carbon-based material as the negative electrode active substance include graphite, graphitizing carbon (soft carbon), non-graphitizing carbon (hard carbon), a carbon nanotube, graphene, and carbon black. Examples of graphite include artificial graphite such as meso-carbon microbeads (MCMB), coke-based artificial graphite, and pitch-based artificial graphite and natural graphite such as spherical natural graphite. In addition, the shape of the graphite is a flaky shape or a spherical shape, for example.

Other than the carbon-based material, a material which enables charge-discharge reactions by an alloying reaction and a dealloying reaction with lithium can be used as the negative electrode active substance. A material containing at least one of Ga, Si, Al, Ge, Sn, Pb, Sb, Bi, Ag, Zn, Cd, In, and the like can be used, for example. Such elements have higher capacity than carbon. In particular, silicon has a significantly high theoretical capacity of 4200 mAh/g and is preferably used. Examples of an alloy-based material (compound-based material) using such elements include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, for the negative electrode active substance, an oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active substance, Li₃₋ₓMₓN (M is Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

When a nitride including lithium and a transition metal are used, lithium ions are included in the negative electrode active substance; thus, the negative electrode active substance can be used in combination with a material for a positive electrode active substance which does not contain lithium ions, such as V₂O₅ or Cr₃O₈. In the case of using a material containing lithium ions as a positive electrode active substance, the nitride containing lithium and a transition metal can be used for the negative electrode active substance by extracting the lithium ions contained in the positive electrode active substance in advance.

Alternatively, a material which causes a conversion reaction can be used for the negative electrode active substance; for example, a transition metal oxide with which an alloying reaction with lithium is not caused, such as cobalt oxide (CoO), nickel oxide (NiO), and iron oxide (FeO), may be used for the negative electrode active substance. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

The particle diameter of the negative electrode active substance is preferably greater than or equal to 50 nm and less than or equal to 100 for example.

The charge and discharge efficiency of the negative electrode is the ratio of discharge capacity to charge capacity and depends on the negative electrode active substance material. In the case of using a plurality of negative electrode active substance materials, the charge and discharge efficiency of the negative electrode is determined not only by the charge and discharge efficiency or capacity of each material but also by the compounding proportion of each material. For example, when s kinds (s is a natural number greater than or equal to 2) of negative electrode active substance materials are mixed, the charge and discharge efficiency Eₙ of the negative electrode can be represented by the equation (2), where Qₜ is the capacity of the tth (t is a natural number from 1 to s) negative electrode active substance material per unit mass, Rₜ is compounding proportion, and Eₜ is the charge and discharge efficiency.

$$\frac{{Q}_{1} {R}_{1} {E}_{1} + {Q}_{2} {R}_{2} {E}_{2} + … + {Q}_{s} {R}_{s} {E}_{s}}{{Q}_{1} {R}_{1} + {Q}_{2} {R}_{2} + … + {Q}_{s} {R}_{s}} = {E}_{n} \qquad ( 2 )$$

When a single material or a plurality of materials are used as the negative electrode active substance, the charge and discharge efficiency of the negative electrode is preferably close to that of the positive electrode so that the above-described positive electrode active substance material having low charge and discharge efficiency can be used for the secondary battery. As in the case of the positive electrode, when an active substance material having low charge and discharge efficiency is used as the negative electrode active substance material, a large amount of positive electrode active substance material is needed to correspond to the irreversible capacity of the negative electrode. However, the increase in the amount of the positive electrode active substance material may be lost as the irreversible capacity of the positive electrode. In other words, the problem caused by the low charge and discharge efficiency of the active substance material can be canceled. Both a high-capacity positive electrode active substance material and a high-capacity negative electrode active substance material usually have low charge and discharge efficiency. This cancellation effect can be utilized to reduce the problem of a waste of a material due to the irreversible capacity even when a high-capacity material is used.

By using a plurality of active substance materials, the charge and discharge efficiency of the positive electrode and that of the negative electrode can further be close to each other. In this case, a material that has high capacity but has relatively low charge and discharge efficiency can be used when compounded into another active substance material; accordingly, the choice of active substance materials can be widened. In addition, a waste of the active substance material of the lithium-ion secondary battery can be reduced and the capacity of the lithium-ion secondary battery can be increased.

For example, in the case of using two kinds of negative electrode active substance materials, in order that the electrode active substances be used without being wasted and prevented from increasing in mass to manufacture a lithium-ion secondary battery with high capacity per unit mass and volume, the charge and discharge efficiency Eₙ of the whole negative electrode is preferably made approximately equal to the charge and discharge efficiency Eₚ of the positive electrode. For that, the compounding proportions of the two kinds of negative electrode active substance materials are considered. Here, the charge and discharge efficiency Eₙ of the whole negative electrode is represented by the equation (3), where Q₁ is the capacity of a first negative electrode active substance per unit mass, R₁ is the compounding proportion, E₁ is the charge and discharge efficiency, Q₂ is the capacity of a second negative electrode active substance per unit mass, R₂ is compounding proportion, and E₂ is charge and discharge efficiency.

$$\frac{{Q}_{1} {R}_{1} {E}_{1} + {Q}_{2} {R}_{2} {E}_{2}}{{Q}_{1} {R}_{1} + {Q}_{2} {R}_{2}} = {E}_{n} \qquad ( 3 )$$

Here, the sum of the compounding proportions of the two kinds of negative electrode active substances is 1. That is, R₁+R₂=1. According to the equation (3), in order that the charge and discharge efficiency of the positive electrode be equal to that of the negative electrode (Eₚ=Eₙ), the compounding proportion of the first negative electrode active substance is preferably the value represented by the equation (4).

$${R}_{1} = \frac{{Q}_{2} ( {E}_{p} - {E}_{2} )}{{Q}_{1} ( {E}_{1} - {E}_{p} ) + {Q}_{2} ( {E}_{p} - {E}_{2} )} \qquad ( 4 )$$

Since R, Q, and E are positive values, the equation (4) is completed if both the value (E₁−Eₚ) and the value (Eₚ−E₂) are positive or negative values, for example. That is, preferably, one of E₁ and E₂ is larger than Eₚ and the other is smaller than Eₚ. Note that if this condition is satisfied, although the equation (4) is not necessarily satisfied, the above-described cancellation effect can at least be obtained.

According to the equation (4), R₁ is 50% if Q₁ (E₁−Eₚ) and Q₂ (Eₚ−E₂) are the same values, in the case where the charge and discharge efficiency of the positive electrode active substance material is higher than that of the first negative electrode active substance material and lower than that of the second negative electrode active substance material. Alternatively, if Q₁ (E₁−Eₚ) is greater than Q₂ (Eₚ−E₂), R₁ is less than 50% and R₂ is greater than R₁. If Q₁ (E₁−Eₚ) is less than Q₂ (Eₚ−E₂), R₁ is greater than 50% and R₂ is less than R₁.

In other words, if the product of the capacity (Q₁) of the first active substance material and the difference (E₁−Eₚ) between the charge and discharge efficiency of the first active substance material and that of the active substance material of the positive electrode is greater than the product of the capacity (Q₂) of the second active substance material and the difference (Eₚ−E₂) between the charge and discharge efficiency of the active substance material of the positive electrode and the charge and discharge efficiency of the second active substance material, the compounding proportion of the first active substance material is less than that of the second active substance material. If the product of the capacity (Q₁) of the first active substance material and the difference (E₁−Eₚ) between the charge and discharge efficiency of the first active substance material and that of the active substance material of the positive electrode is less than the product of the capacity (Q₂) of the second active substance material and the difference (Eₚ−E₂) between the charge and discharge efficiency of the active substance material of the positive electrode and the charge and discharge efficiency of the second active substance material, the compounding proportion of the first active substance material is greater than that of the second active substance material. Note that if this condition is satisfied, although the equation (4) is not necessarily satisfied, the above-described cancellation effect can at least be obtained.

In these conditions, the positive electrode and the negative electrode may be replaced with each other. In other words, similar conditions apply when a plurality of active substance materials are used as the positive electrode.

Examples of the conductive additive include acetylene black (AB), graphite (black lead) particles, carbon nanotubes, graphene, and fullerene.

A network for electron conduction can be formed in the electrode by the conductive additive. The conductive additive also allows maintaining of a path for electric conduction between the particles of the negative electrode active substance material. The addition of the conductive additive to the negative electrode active substance layer increases the electron conductivity of the negative electrode active substance layer 103.

A typical example of the binder is polyvinylidene fluoride (PVDF), and other examples of the binder include polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, and nitrocellulose.

The content of the binder in the negative electrode active substance layer 103 is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %. The content of the conductive additive in the negative electrode active substance layer 103 is preferably greater than or equal to 1 wt % and less than or equal to 10 wt %, more preferably greater than or equal to 1 wt % and less than or equal to 5 wt %.

Next, the negative electrode active substance layer 103 is formed over the negative electrode current collector 102. In the case where the negative electrode active substance layer 103 is formed by a coating method, the negative electrode active substance, the binder, the conductive additive, and a dispersion medium are mixed to form an electrode paste (slurry), and the electrode paste is applied to the negative electrode current collector 102 and dried. If necessary, pressing may be performed after the drying.

In this embodiment, metal foil of copper is used as the negative electrode current collector 102, and a mixture of meso-carbon microbeads and polyvinylidene fluoride (PVDF) as the binder is used as the slurry.

The negative electrode current collector 102 can be formed using a material, which has high conductivity and is not alloyed with carrier ions of lithium or the like, such as stainless steel, gold, platinum, iron, copper, titanium, or tantalum, or an alloy thereof. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The negative electrode current collector 102 can have a foil shape, a plate (sheet) shape, a net shape, a punching-metal shape, an expanded-metal shape, or the like as appropriate. The negative electrode current collector 102 preferably has a thickness greater than or equal to 5 μm and less than or equal to 30 μm. A part of the surface of the electrode current collector may be provided with an undercoat layer using graphite or the like.

Through the above steps, the negative electrode of the lithium-ion secondary battery can be fabricated.

The separator 104 is described. The separator 104 may be formed using a material such as paper, nonwoven fabric, a glass fiber, a synthetic fiber such as nylon (polyamide), vinylon (a polyvinyl alcohol based fiber), polyester, acrylic, polyolefin, or polyurethane. However, a material that does not dissolve in an electrolyte solution described later needs to be selected.

More specifically, as a material for the separator 104, high-molecular compounds based on fluorine-based polymer, polyether such as polyethylene oxide and polypropylene oxide, polyolefin such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane, derivatives thereof, cellulose, paper, nonwoven fabric, and a glass fiber can be used either alone or in combination.

The separator 104 needs to have insulation performance that prevents connection between the electrodes, performance that holds the electrolyte solution, and ionic conductivity. As a method of forming a film having a function as a separator, a method of forming a film by stretching is given. Examples of the method include a stretching aperture method in which a melted polymer material is spread, heat is released from the material, and pores are formed by stretching the resulting film in the directions of two axes parallel to the film.

To set the separator 104 in a secondary battery, a method in which the separator is inserted between the positive electrode and the negative electrode can be used. Alternatively, a method in which the separator 104 is placed on one of the positive electrode and the negative electrode and then the other of the positive electrode and the negative electrode is placed thereon can be used. The positive electrode, the negative electrode, and the separator are stored in the exterior body, and the exterior body is filled with the electrolyte solution, whereby the secondary battery can be formed.

The separator 104 with a size large enough to cover each surface of either the positive electrode or the negative electrode, in a form of sheet or envelope may be fabricated to form the electrode wrapped in the separator 104. In that case, the electrode can be protected from mechanical damages in the manufacture of the secondary battery and the handling of the electrode becomes easier. The electrode wrapped in the separator and the other electrode are stored in the exterior body, and the exterior body is filled with the electrolyte solution, whereby the secondary battery can be formed.

The separator 104 may be a plurality of layers. Although the separator 104 can be formed by the above method, the range of the thickness of the film and the size of the pore in the film of the separator 104 is limited by a material of the separator and mechanical strength of the film. A first separator and a second separator each formed by a stretching method may be used together in a secondary battery. The first separator and the second separator can be formed using one or more kinds of material selected from the above-described materials or materials other than those described above. Characteristics such as the size of the pore in the film, the proportion of the volume of the pores in the film (also referred to as porosity), and the thickness of the film can be determined by film formation conditions, film stretching conditions, and the like. By using the first separator and the second separator having different characteristics, the performance of the separators of the secondary battery can be selected more variously than in the case of using one of the separators.

The secondary battery may be flexible. In the case where flow stress is applied to the flexible secondary battery, the stress can be relieved by sliding of the first separator and the second separator at the interface between the separators. Therefore, the structure including the two separators is also suitable as a structure of a separator in a flexible secondary battery.

The electrolyte solution 105 used in the lithium-ion secondary battery is preferably a nonaqueous solution (solvent) containing an electrolyte (solute).

As a solvent for the electrolyte solution 105, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

When a gelled polymer material is used as the solvent of the electrolyte solution 105, safety against liquid leakage and the like is improved. Further, the lithium-ion secondary battery can be thinner and more lightweight. Typical examples of the gelled high-molecular material include a silicone gel, an acrylic gel, an acrylonitrile gel, polyethylene oxide, polypropylene oxide, a fluorine-based polymer, and the like.

Alternatively, the use of one or more of ionic liquids (room temperature molten salts) that have non-flammability and non-volatility as the solvent for the electrolyte solution can prevent a lithium-ion secondary battery from exploding or catching fire even when the lithium-ion secondary battery internally shorts out or the internal temperature increases due to overcharging or the like. Thus, the lithium-ion secondary battery has improved safety.

Examples of an electrolyte dissolved in the above-described solvent are one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂, or two or more of these lithium salts in an appropriate combination in an appropriate ratio.

Although the case where carrier ions are lithium ions in the above electrolyte is described, carrier ions other than lithium ions can be used. When the carrier ions other than lithium ions are alkali metal ions or alkaline-earth metal ions, instead of lithium in the lithium salts, an alkali metal (e.g., sodium or potassium) or an alkaline-earth metal (e.g., calcium, strontium, barium, beryllium, or magnesium) may be used as the electrolyte.

The electrolyte solution used for the secondary battery is preferably a highly purified one so as to contain a negligible amount of dust particles and elements other than the constituent elements of the electrolyte solution (hereinafter, also simply referred to as impurities). Specifically, the mass ratio of impurities to the electrolyte solution is less than or equal to 1%, preferably less than or equal to 0.1%, and more preferably less than or equal to 0.01%. An additive agent such as vinylene carbonate may be added to the electrolyte solution.

Next, the exterior body 106 is described. As the exterior body 106, a film having a three-layer structure can be used, for example. In the three-layer structure, a highly flexible metal thin film of, for example, aluminum, stainless steel, copper, and nickel is provided over a film formed of a material such as polyethylene, polypropylene, polycarbonate, ionomer, and polyamide, and an insulating synthetic resin film of, for example, a polyamide-based resin or a polyester-based resin is provided as the outer surface of the exterior body over the metal thin film. With such a three-layer structure, permeation of an electrolyte solution and a gas can be blocked and an insulating property and resistance to the electrolyte solution can be provided. The exterior body is folded inside in two, or two exterior bodies are stacked with the inner surfaces facing each other, in which case application of heat melts the materials on the overlapping inner surfaces to cause fusion bonding between the two exterior bodies. In this manner, a sealing structure can be formed.

A portion where the sealing structure is formed by fusion bonding or the like of the exterior body is referred to as a sealing portion. In the case where the exterior body is folded inside in two, the sealing portion is formed in the place other than the fold, and a first region of the exterior body and a second region of the exterior body that overlaps with the first region are fusion-bonded, for example. In the case where two exterior bodies are stacked, the sealing portion is formed along the entire circumference by heat fusion bonding or the like.

When a flexible material is selected from materials of the members described in this embodiment and used, a flexible lithium-ion secondary battery can be manufactured. Deformable devices are currently under active research and development. For such devices, flexible secondary batteries are demanded.

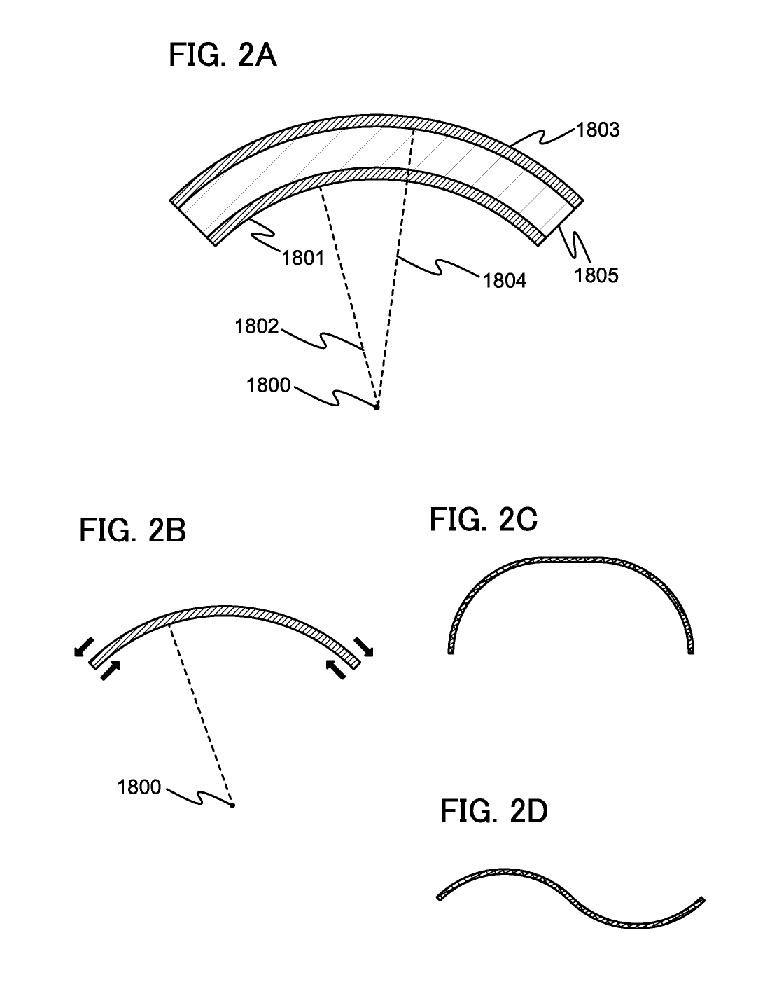

In the case of bending a secondary battery in which a component 1805 including electrodes and an electrolytic solution is sandwiched between two films as exterior bodies, a radius 1802 of curvature of a film 1801 close to a center 1800 of curvature of the secondary battery is smaller than a radius 1804 of curvature of a film 1803 far from the center 1800 of curvature (FIG. 2A). When the secondary battery is curved and has an arc-shaped cross section, compressive stress is applied to a surface of the film on the side closer to the center 1800 of curvature and tensile stress is applied to a surface of the film on the side farther from the center 1800 of curvature (FIG. 2B).

When a flexible lithium-ion secondary battery is deformed, strong stress is applied to the exterior bodies. However, even with the compressive stress and tensile stress due to the deformation of the secondary battery, the influence of a strain can be reduced by forming a pattern including projections or depressions on surfaces of the exterior bodies. For this reason, the secondary battery can change its form such that the exterior body on the side closer to the center of curvature has a curvature radius of 30 mm, possibly 10 mm.

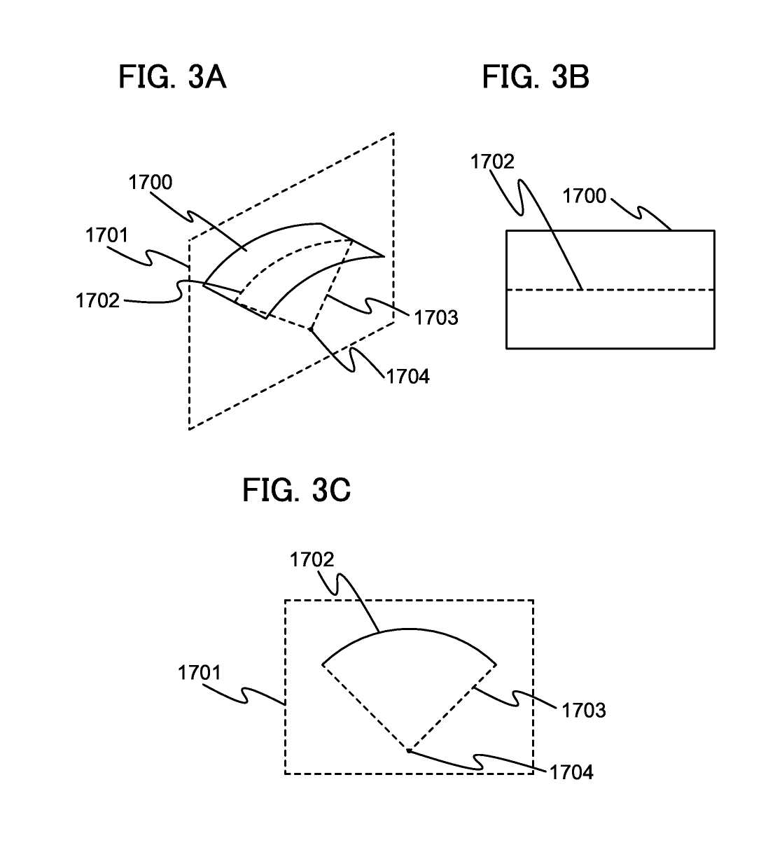

The radius of curvature of a surface is described with reference to FIGS. 3A to 3C. In FIG. 3A, on a plane 1701 along which a curved surface 1700 is cut, part of a curve 1702 forming the curved surface 1700, is approximate to an arc of a circle; the radius of the circle is referred to as a radius of curvature 1703 and the center of the circle is referred to as a center of curvature 1704. FIG. 3B is a top view of the curved surface 1700. FIG. 3C is a cross-sectional view of the curved surface 1700 taken along the plane 1701. When a curved surface is cut by a plane, the radius of curvature of a curve in a cross section differs depending on the angle between the curved surface and the plane or on the cut position, and the smallest radius of curvature is defined as the radius of curvature of a surface in this specification and the like.

Note that the cross-sectional shape of the secondary battery is not limited to a simple arc shape, and the cross section can be partly arc-shaped; for example, a shape illustrated in FIG. 2C, a wavy shape illustrated in FIG. 2D, or an S shape can be used. When the curved surface of the secondary battery has a shape with a plurality of centers of curvature, the secondary battery can change its form such that a curved surface with the smallest radius of curvature among radii of curvature with respect to the plurality of centers of curvature, which is a surface of the exterior body on the side closer to the center of curvature, has a curvature radius of 30 mm, possibly 10 mm.

Although an example of use in a lithium-ion secondary battery is described in this embodiment, one embodiment of the present invention is not limited to this example. Application to a variety of secondary batteries such as a lead secondary storage battery, a lithium-ion polymer secondary battery, a nickel-hydrogen secondary battery, a nickel-cadmium secondary battery, a nickel-iron secondary battery, a nickel-zinc secondary battery, a silver oxide-zinc secondary battery, a solid-state battery, and an air battery is also possible. Application to a variety of power storage devices such as a primary battery, a capacitor, and a lithium-ion capacitor is also possible.

This embodiment can be implemented in appropriate combination with any of the other embodiments and examples.

### Embodiment 2

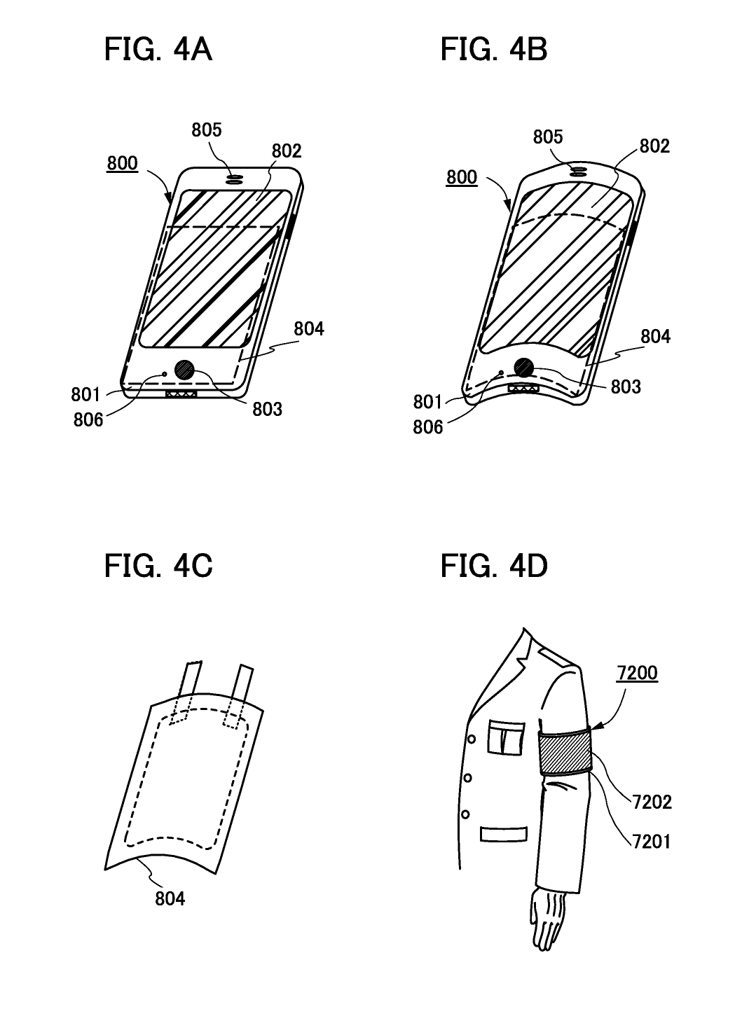

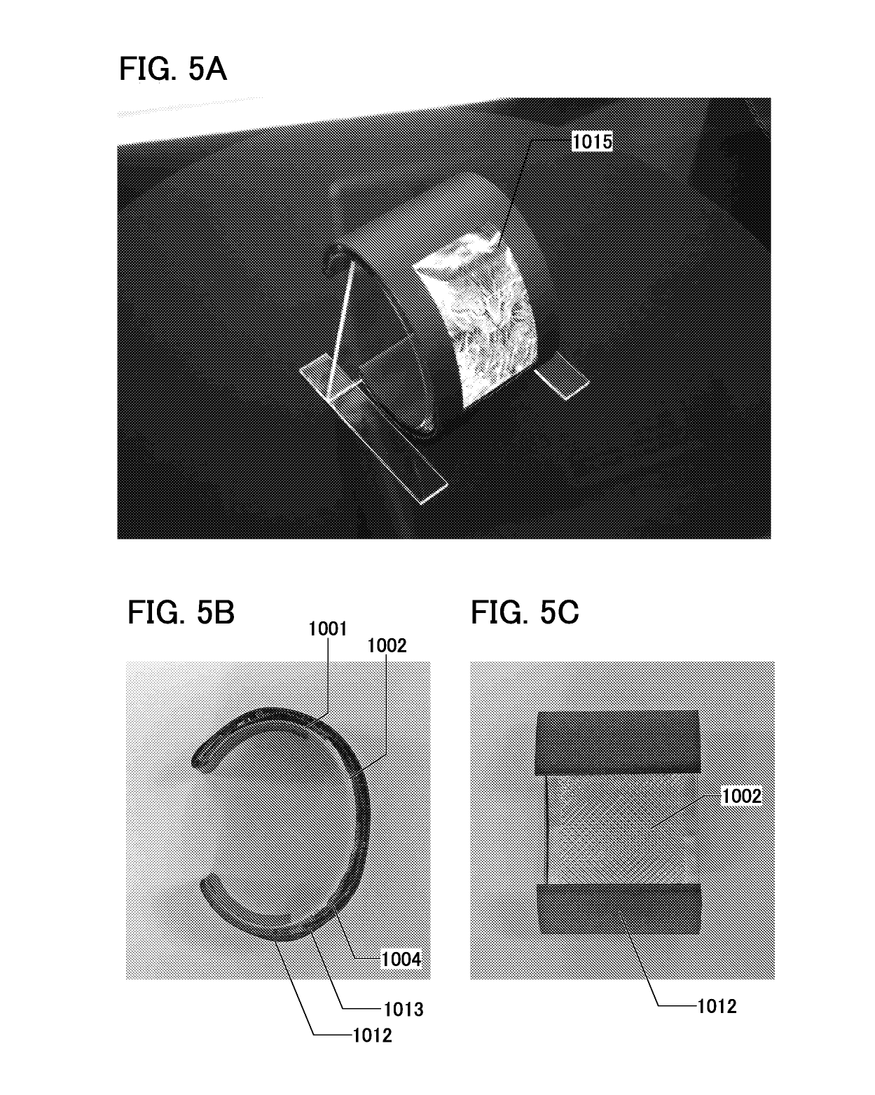

In this embodiment, examples of electronic appliances including the secondary battery described in the above embodiment are described with reference to FIGS. 4A to 4D and FIGS. 5A to 5C.

Examples of the electronic appliances including the secondary battery are cameras such as digital cameras and digital video cameras, digital photo frames, mobile phones (also referred to as cellular phones or portable telephone devices), portable game consoles, portable information terminals, and audio reproducing devices. FIGS. 4A to 4D and FIGS. 5A to 5C illustrate specific examples of these electronic appliances.

FIG. 4A illustrates an example of a mobile phone. A mobile phone 800 is provided with a display portion 802 incorporated in a housing 801, an operation button 803, a speaker 805, a microphone 806, and the like. The use of a secondary battery 804 of one embodiment of the present invention in the mobile phone 800 results in a weight reduction.

When the display portion 802 of the mobile phone 800 illustrated in FIG. 4A is touched with a finger or the like, data can be input into the mobile phone 800. Users can make a call or text messaging by touching the display portion 802 with their fingers or the like.

There are mainly three screen modes for the display portion 802. The first mode is a display mode mainly for displaying an image. The second mode is an input mode mainly for inputting data such as characters. The third mode is a display-and-input mode in which two modes of the display mode and the input mode are combined.

For example, in the case of making a call or composing an e-mail, a text input mode mainly for inputting text is selected for the display portion 802 so that text displayed on a screen can be inputted.

When a sensing device including a sensor such as a gyroscope and an acceleration sensor for detecting inclination is provided in the mobile phone 800, display on the screen of the display portion 802 can be automatically switched by determining the orientation of the mobile phone 800 (whether the mobile phone 800 is placed horizontally or vertically for a landscape mode or a portrait mode).

The screen modes are switched by touching the display portion 802 or operating the operation button 803 of the housing 801. Alternatively, the screen modes may be switched depending on the kind of the image displayed on the display portion 802. For example, when a signal of an image displayed on the display portion is a signal of moving image data, the screen mode is switched to the display mode. When the signal is a signal of text data, the screen mode is switched to the input mode.

Moreover, in the input mode, if a signal detected by an optical sensor in the display portion 802 is detected and the input by touch on the display portion 802 is not performed for a certain period, the screen mode may be controlled so as to be switched from the input mode to the display mode.

The display portion 802 can function as an image sensor. For example, an image of a palm print, a fingerprint, or the like is taken with the display portion 802 touched with the palm or the finger, whereby personal authentication can be performed. Furthermore, by providing a backlight or a sensing light source that emits near-infrared light in the display portion, an image of a finger vein, a palm vein, and the like can be taken.

FIG. 4B illustrates the mobile phone 800 which is bent. When the whole mobile phone 800 is bent by the external force, the secondary battery 804 included in the mobile phone 800 is also bent. FIG. 4C illustrates the bent secondary battery 804. The secondary battery 804 is a secondary battery having a stacked-layer structure.

FIG. 4D illustrates an example of an armband display device. An armband display device 7200 includes a housing 7201 and a display portion 7202. Although not shown, a flexible secondary battery is included in the armband display device 7200. The flexible secondary battery changes in shape in accordance with a change in the shape of the armband display device 7200.

Note that the structure and the like described in this embodiment can be used as appropriate in combination with any of the structures and the like in the other embodiments.

### Embodiment 3

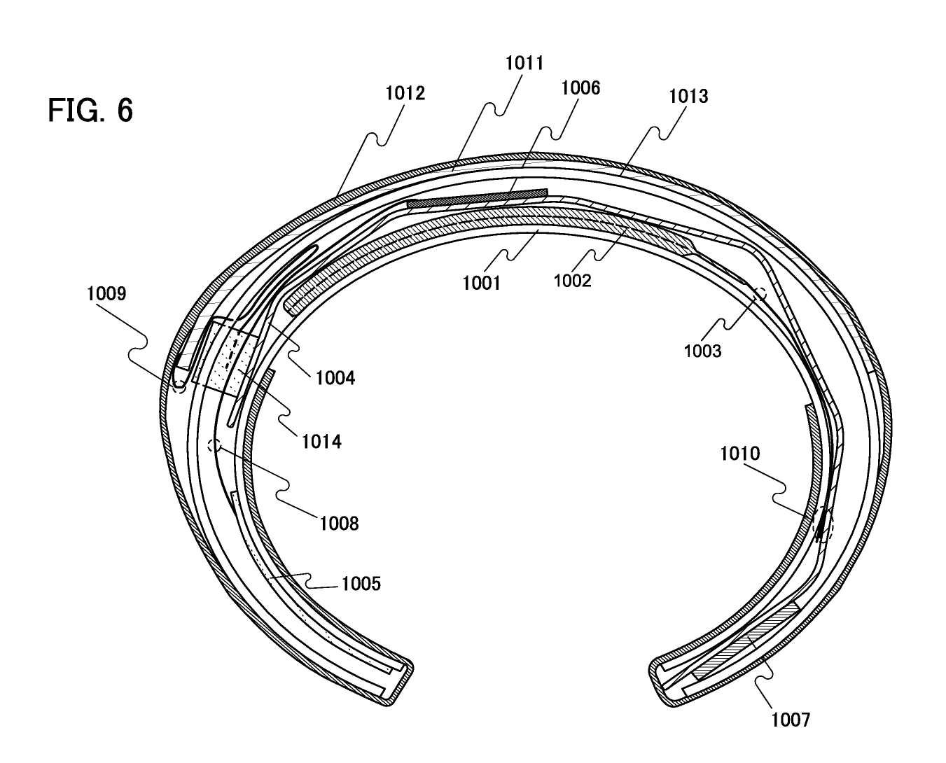

In this embodiment, examples of electronic appliances incorporating the lithium-ion secondary battery obtained according to Embodiment 1 are described. FIG. 5A shows a photograph of the appearance of an electronic appliance incorporating the lithium-ion secondary battery obtained according to Embodiment 1. FIG. 5B shows a photograph of the electronic appliance taken from a side, and FIG. 5C shows a photograph of the electronic appliance taken from a back side. FIG. 6 is a schematic side view of a structure of the electronic appliance.

The electronic appliance illustrated in FIGS. 5A to 5C and FIG. 6 is a display device that can be put on an arm and display an image or information. The flexibility of the lithium-ion secondary battery achieves a shape fit to an arm, and enables an appearance with an attractive design and use as an accessory.

The electronic appliance illustrated in FIGS. 5A to 5C and FIG. 6 includes the support structure body 1001, the secondary battery 1002, a control board 1004, a display module 1011, a protective member 1013, and a cover 1012. Specifically, the secondary battery 1002, the control board 1004, the protective member 1013, the display module 1011, and the cover 1012 are provided in this order over the support structure body 1001. In addition, the electronic appliance is provided with an antenna 1005 for wireless charging, and the wireless charging can be performed according to the Qi standard. The electronic appliance includes a communication device 1007 for wirelessly communicating data to be used to perform display with an external device.

The secondary battery 1002 of one embodiment according to Embodiment 1 includes, as an exterior body, a thin film having flexibility and thus can be bonded to a support structure body 1001 with a curved surface and can change its form along the curved surface of a region of the support structure body 1001 which has a large radius of curvature.

When a light-transmitting plastic substrate is used as the support structure body 1001 in the electronic appliance as illustrated in FIGS. 5B and 5C, the secondary battery 1002 can be visually recognized from the back surface side of the electronic appliance and a surface of an embossed film can be observed.

The support structure body 1001 is flexible and thus can be easily bent. Note that a material other than plastic can be used for the support structure body 1001. The support structure body 1001 is in the form of a bracelet obtained by curving a band-like structure body. In addition, the support structure body 1001 is partly flexible, and the electronic appliance can be worn on a wrist while the support structure body 1001 is changed in form.

The protective member 1013 protects a component inside the electronic appliance, in particular, the control board 1004 from a sudden shock. The protective member can change its form as a part of the electronic appliance and thus can be made of a material similar to that of the support structure body 1001. Note that the protective member 1013 may be made of a material different from that of the support structure body 1001.

The cover 1012 is a light-blocking film having one surface coated with an adhesive and covers the whole of the electronic appliance to bring components together and has an opening in the display portion 1015. The cover 1012 can conceal the internal structure owing to its light-blocking property, improving the design of the electronic appliance. Note that the electronic appliance may be intentionally formed so that its internal structure can be seen externally. In that case, the cover 1012 does not have to have a light-blocking property. Also in the case where the protective member 1013 has a light-blocking property, the cover 1012 does not have to have a light-blocking property.

The control board 1004 has slits to bend it, and is provided with a communication device 1007 conforming to Bluetooth (registered trademark, the same as IEEE802.15.1) standards, a microcomputer, a storage device, an FPGA, a DA converter, a charge control IC, a level shifter, and the like. In addition, the control board 1004 is connected to a display module 1011 including a display portion 1015 through an input/output connector 1014. In addition, the control board 1004 is connected to the antenna 1005 through a wiring 1008 and connected to the secondary battery 1002 through a wiring 1003 and a connection portion 1010. A power supply control circuit 1006 controls charge and discharge of the secondary battery 1002.

The display module 1011 refers to a display panel provided with at least an FPC 1009. The electronic appliance in FIG. 6 includes the display portion 1015, the FPC 1009, and a driver circuit and preferably further includes a converter for power feeding from the secondary battery 1002.

In the display module 1011, the display portion 1015 is flexible and a display element is provided over a soft and flexible film. The secondary battery 1002 and the display portion are preferably disposed so as to partly overlap with each other. When the secondary battery 1002 and the display portion are disposed so as to partly or entirely overlap with each other, the electrical path, i.e., the length of a wiring, from the secondary battery 1002 to the display portion 1015 can be shortened, whereby power consumption can be reduced. In addition, providing the display module between the protective member 1013 and the cover 1012 enables protection of the display module 1011 from unexpected deformation (e.g., wrinkles or a twist), increasing the lifetime of the electronic appliance as a product.

Examples of methods for forming the display element over the flexible film include a method in which the display element is directly formed over the flexible film; a method in which a layer including the display element is formed over a rigid substrate such as a glass substrate, the substrate is removed by etching, polishing, or the like, and then the layer including the display element and the flexible film are attached to each other; and a method in which a separation layer is provided over a rigid substrate such as a glass substrate, a layer including the display element is formed thereover, the rigid substrate and the layer including the display element are separated from each other using the separation layer, and then the layer including the display element and the flexible film are attached to each other.

In addition, the display portion 1015 may be provided with a touchscreen so that input of data to the electronic appliance and operation of the electronic appliance can be performed with the touchscreen.

Note that the structure and the like described in this embodiment can be used as appropriate in combination with any of the structures and the like in the other embodiments.

Note that what is described (or part thereof) in one embodiment can be applied to, combined with, or replaced with different contents in the embodiment and/or what is described (or part thereof) in another embodiment or other embodiments.

Note that in each embodiment, what is described in the embodiment is contents described with reference to a variety of diagrams or contents described with text described in this specification.

Note that by combining a diagram (or may be part of the diagram) illustrated in one embodiment with another part of the diagram, a different diagram (or may be part of the different diagram) illustrated in the embodiment, and/or a diagram (or may be part of the diagram) illustrated in another embodiment or other embodiments, much more diagrams can be formed.

Note that contents that are not specified in any drawing or text in the specification can be excluded from one embodiment of the invention. Alternatively, when the range of a value that is defined by the maximum and minimum values is described, part of the range is appropriately narrowed or part of the range is removed, whereby one embodiment of the invention excluding part of the range can be constituted. In this manner, it is possible to specify the technical scope of one embodiment of the present invention so that a conventional technology is excluded, for example.

As a specific example, a diagram of a circuit including first to fifth transistors is illustrated. In that case, it can be specified that the circuit does not include a sixth transistor in the invention. It can be specified that the circuit does not include a capacitor in the invention. It can be specified that the circuit does not include a sixth transistor with a particular connection structure in the invention. It can be specified that the circuit does not include a capacitor with a particular connection structure in the invention. For example, it can be specified that a sixth transistor whose gate is connected to a gate of the third transistor is not included in the invention. For example, it can be specified that a capacitor whose first electrode is connected to the gate of the third transistor is not included in the invention.

As another specific example, the description of a value, “a voltage is preferably higher than or equal to 3 V and lower than or equal to 10 V” is given. In that case, for example, it can be specified that the case where the voltage is higher than or equal to −2 V and lower than or equal to 1 V is excluded from one embodiment of the invention. For example, it can be specified that the case where the voltage is higher than or equal to 13 V is excluded from one embodiment of the invention. Note that, for example, it can be specified that the voltage is higher than or equal to 5 V and lower than or equal to 8 V in the invention. For example, it can be specified that the voltage is approximately 9 V in the invention. For example, it can be specified that the voltage is higher than or equal to 3 V and lower than or equal to 10 V but is not 9 V in the invention. Note that even when the description “a value is preferably in a certain range” or “a value preferably satisfies a certain condition” is given, the value is not limited to the description. In other words, a description of a value that includes a term “preferable”, “preferably”, or the like does not necessarily limit the value.

As another specific example, the description “a voltage is preferably 10 V” is given. In that case, for example, it can be specified that the case where the voltage is higher than or equal to −2 V and lower than or equal to 1 V is excluded from one embodiment of the invention. For example, it can be specified that the case where the voltage is higher than or equal to 13 V is excluded from one embodiment of the invention.

As another specific example, the description “a film is an insulating film” is given to describe a property of a material. In that case, for example, it can be specified that the case where the insulating film is an organic insulating film is excluded from one embodiment of the invention. For example, it can be specified that the case where the insulating film is an inorganic insulating film is excluded from one embodiment of the invention. For example, it can be specified that the case where the insulating film is a conductive film is excluded from one embodiment of the invention. For example, it can be specified that the case where the insulating film is a semiconductor film is excluded from one embodiment of the invention.

As another specific example, the description of a stacked-layer structure, “a film is provided between an A film and a B film” is given. In that case, for example, it can be specified that the case where the film is a layered film of four or more layers is excluded from the invention. For example, it can be specified that the case where a conductive film is provided between the A film and the film is excluded from the invention.

Note that various people can implement one embodiment of the invention described in this specification and the like. However, different people may be involved in the implementation of the embodiment of the invention. For example, in the case of a transmission/reception system, the following case is possible: Company A manufactures and sells transmitting devices, and Company B manufactures and sells receiving devices. As another example, in the case of a light-emitting device including a transistor and a light-emitting element, the following case is possible: Company A manufactures and sells semiconductor devices including transistors, and Company B purchases the semiconductor devices, provides light-emitting elements for the semiconductor devices, and completes light-emitting devices.

In such a case, one embodiment of the invention can be constituted so that a patent infringement can be claimed against each of Company A and Company B. In other words, one embodiment of the invention can be constituted so that only Company A implements the embodiment, and another embodiment of the invention can be constituted so that only Company B implements the embodiment. One embodiment of the invention with which a patent infringement suit can be filed against Company A or Company B is clear and can be regarded as being disclosed in this specification or the like. For example, in the case of a transmission/reception system, even when this specification or the like does not include a description of the case where a transmitting device is used alone or the case where a receiving device is used alone, one embodiment of the invention can be constituted by only the transmitting device and another embodiment of the invention can be constituted by only the receiving device. Those embodiments of the invention are clear and can be regarded as being disclosed in this specification or the like. Another example is as follows: in the case of a light-emitting device including a transistor and a light-emitting element, even when this specification or the like does not include a description of the case where a semiconductor device including the transistor is used alone or the case where a light-emitting device including the light-emitting element is used alone, one embodiment of the invention can be constituted by only the semiconductor device including the transistor and another embodiment of the invention can be constituted by only the light-emitting device including the light-emitting element. Those embodiments of the invention are clear and can be regarded as being disclosed in this specification or the like.

Note that in this specification and the like, it may be possible for those skilled in the art to constitute one embodiment of the invention even when portions to which all the terminals of an active element (e.g., a transistor or a diode), a passive element (e.g., a capacitor or a resistor), and the like are connected are not specified. In other words, one embodiment of the invention is clear even when connection portions are not specified. Further, in the case where a connection portion is disclosed in this specification and the like, it can be determined that one embodiment of the invention in which a connection portion is not specified is disclosed in this specification and the like, in some cases. In particular, in the case where the number of portions to which the terminal is connected may be more than one, it is not necessary to specify the portions to which the terminal is connected. Therefore, it may be possible to constitute one embodiment of the invention by specifying only portions to which some of terminals of an active element (e.g., a transistor or a diode), a passive element (e.g., a capacitor or a resistor), and the like are connected.

Note that in this specification and the like, it may be possible for those skilled in the art to specify the invention when at least the connection portion of a circuit is specified. Alternatively, it may be possible for those skilled in the art to specify the invention when at least a function of a circuit is specified. In other words, when a function of a circuit is specified, one embodiment of the present invention is clear. Moreover, it can be determined that one embodiment of the present invention whose function is specified is disclosed in this specification and the like. Therefore, when a connection portion of a circuit is specified, the circuit is disclosed as one embodiment of the invention even when a function is not specified, and one embodiment of the invention can be constituted. Alternatively, when a function of a circuit is specified, the circuit is disclosed as one embodiment of the invention even when a connection portion is not specified, and one embodiment of the invention can be constituted.

Note that in this specification and the like, part of a diagram or text described in one embodiment can be taken out to constitute one embodiment of the invention. Thus, in the case where a diagram or text related to a certain portion is described, the contents taken out from part of the diagram or the text are also disclosed as one embodiment of the invention, and one embodiment of the invention can be constituted. The embodiment of the present invention is clear. Therefore, for example, in a diagram or text in which one or more active elements (e.g., transistors or diodes), wirings, passive elements (e.g., capacitors or resistors), conductive layers, insulating layers, semiconductor layers, organic materials, inorganic materials, components, devices, operating methods, manufacturing methods, or the like are described, part of the diagram or the text is taken out, and one embodiment of the invention can be constituted. For example, from a circuit diagram in which N circuit elements (e.g., transistors or capacitors; N is an integer) are provided, it is possible to take out M circuit elements (e.g., transistors or capacitors; M is an integer, where M<N) and constitute one embodiment of the invention. For another example, it is possible to take out M layers (M is an integer, where M<N) from a cross-sectional view in which N layers (N is an integer) are provided and constitute one embodiment of the invention. For another example, it is possible to take out M elements (M is an integer, where M<N) from a flow chart in which N elements (N is an integer) are provided and constitute one embodiment of the invention. For another example, it is possible to take out some given elements from a sentence “A includes B, C, D, E, or F” and constitute one embodiment of the invention, for example, “A includes B and E”, “A includes E and F”, “A includes C, E, and F”, or “A includes B, C, D, and E”.

Note that in the case where at least one specific example is described in a diagram or text described in one embodiment in this specification and the like, it will be readily appreciated by those skilled in the art that a broader concept of the specific example can be derived. Therefore, in the diagram or the text described in one embodiment, in the case where at least one specific example is described, a broader concept of the specific example is disclosed as one embodiment of the invention, and one embodiment of the invention can be constituted. The embodiment of the present invention is clear.

Note that in this specification and the like, what is illustrated in at least a diagram (which may be part of the diagram) is disclosed as one embodiment of the invention, and one embodiment of the invention can be constituted. Therefore, when certain contents are described in a diagram, the contents are disclosed as one embodiment of the invention even when the contents are not described with text, and one embodiment of the invention can be constituted. In a similar manner, part of a diagram, which is taken out from the diagram, is disclosed as one embodiment of the invention, and one embodiment of the invention can be constituted. The embodiment of the present invention is clear.

### EXAMPLE 1

In this example, a fabrication process of negative electrodes each using a negative electrode active substance obtained by mixing a carbon-based material (graphite) and a compound-based material containing oxygen and silicon is described.

### [Fabrication of Negative Electrodes]

The electrodes were fabricated using a carbon-based material (graphite) and a compound-based material containing oxygen and silicon as an active substance. The fabricated were four kinds of electrodes, and the compounding ratios of the carbon-based material (graphite) to the compound-based material containing oxygen and silicon were as follows: 100:0 (electrode A, for comparison), 95:5 (electrode B), 93:7 (electrode C), and 90:10 (electrode D).

Conditions for the electrodes were as follows: the ratio of the active substance (in which the carbon-based material (graphite) and the compound-based material containing oxygen and silicon were compounded at the above ratio) to VGCF, CMC, and SBR was 96:1:1:2 to form coated electrodes. As a conductive additive, VGCF (registered trademark)-H (manufactured by SHOWA DENKO K.K., the fiber diameter: 150 nm, the specific surface area: 13 m²/g), which is vapor grown carbon fiber, was used.

Next, a method of fabricating the electrodes is described. The polymerization degree of CMC-Na used to fabricate the electrodes was 600 to 800, and the viscosity of a 1% CMC-Na aqueous solution was in the range from 300 mPa·s to 500 mPa·s. Next, a paste was formed. Mixing was performed with a planetary mixer. A container with a volume of 5 ml to 250 ml inclusive, was used for the mixing.

First, an aqueous solution was prepared in such a manner that CMC-Na was uniformly dissolved in pure water. Then, the carbon-based material (graphite) and the compound-based material containing oxygen and silicon were weighed, VGCF was weighed, and the CMC-Na aqueous solution was added thereto.

Then, the mixture of these materials was kneaded in a mixer for 5 minutes. The kneading was performed 5 times to form the paste. Here, kneading means mixing something so that it has a high viscosity.

Then, a 50 wt % SBR aqueous dispersion liquid was added to the mixture, and mixing was performed with a mixer for 5 minutes.

Then, degasification was performed while the pressure was reduced. The pressure in the mixer containing this mixture was reduced and degasification was performed for 20 minutes. The pressure was adjusted so that a pressure difference from the atmospheric pressure was 0.096 MPa or less. Through the above steps, the paste was formed.

Subsequently, the paste was applied to a current collector with the use of a continuous coater. An 18-μm-thick rolled copper foil was used as the current collector. Here, the supported amount of the active substance material was set to approximately 8 mg/cm². The coating speed was set to 1 m/min.

Subsequently, the coated electrodes were dried in a drying furnace. The electrodes were dried at 50° C. in an air atmosphere for 90 seconds and then further dried at 75° C. in the air atmosphere for 90 seconds.

After the drying in the drying furnace, further drying was performed at 100° C. under a reduced pressure for 10 hours.

Through the above steps, the electrodes A to D were fabricated.

### EXAMPLE 2

In this example, half-cells were fabricated using the electrodes formed in Example 1, and the charge and discharge characteristics thereof were measured.

### [Characteristics of Half-Cells]

Each half-cell was fabricated using the electrode formed in Example 1 and a lithium metal as a counter electrode. The characteristics were measured with the use of a CR2032 coin-type secondary battery (with a diameter of 20 mm and a height of 3.2 mm). For a separator, a stack of polypropylene and GF/C, which is Whatman (registered trademark) glass-fiber filter paper, was used. An electrolytic solution was formed in such a manner that lithium hexafluorophosphate (LiPF₆) was dissolved at a concentration of 1 mol/L in a mixed solution in which ethylene carbonate (EC) and diethyl carbonate (DEC) were mixed at a volume ratio of 3:7. A positive electrode can and a negative electrode can were formed of stainless steel (SUS).

Next, the fabricated half-cells were charged and discharged. The supported amount of each electrode used was set to 8 mg/cm². The measurement temperature was 25° C. The conditions for charge and discharge in the first and second cycles are as follows. The discharge (Li intercalation) was performed in the following manner: constant current discharge was performed at a rate of 0.1 C with the lower limit set to 0.01 V, and then, constant voltage discharge was performed at 0.01 V with the lower limit set to a current value corresponding to 0.01 C. As the charge (Li deintercalation), constant current charge was performed at a rate of 0.1 C with the upper limit set to 1 V. The initial charge and discharge efficiency was obtained by dividing the initial charge capacity by discharge capacity (charge capacity discharge capacity×100 [%]). Twenty cycles of the above charge and discharge were performed.

Table 1 shows charge capacity with respect to discharge capacity in the first cycle as initial charge and discharge efficiency (charge capacity discharge capacity×100 [%]). For reference, an electrode in which the compounding proportion of the carbon-based material is 0 (electrode E) is also shown in Table 1.

TABLE 1

| | Compounding ratio | | | Charge |
|---|---|---|---|---|
| | (carbon-based | Charge | Discharge | and |
| | material:compound- | capacity | capacity | discharge |
| | based material) | (mA/g) | (mA/g) | efficiency |
| Electrode A | 100:0 | 381.6 | 361.2 | 94.65% |
| (reference) | | | | |
| Electrode B | 95:5 | 479.1 | 412.3 | 86.06% |
| Electrode C | 93:7 | 526.5 | 438.5 | 83.29% |
| Electrode D | 90:10 | 581.5 | 466.8 | 80.28% |
| Electrode E | 0:100 | 3026 | 2088 | 69.00% |
| (reference) | | | | |

### EXAMPLE 3

In this example, lithium-manganese composite oxide used for the positive electrode active substance material was synthesized by the manufacturing method described in Embodiment 1.

### [Synthesis of Lithium-Manganese Composite Oxide]

First, a positive electrode active substance containing lithium-manganese composite oxide was fabricated. Starting materials Li₂CO₃, MnCO₃, and NiO were weighed so that the molar ratio of Li₂CO₃ to MnCO₃ and NiO was 0.84:0.8062:0.318. To form a comparison sample B, starting materials Li₂CO₃ and MnCO₃ were weighed so that the molar ratio of Li₂CO₃ to MnCO₃ was 1:1.

Next, ethanol was added to the powder of these materials, and then, they were mixed using 0.5-mm-diameter beads in a bead mill for 30 minutes at a peripheral speed of 10 m/s to prepare a mixed powder.

After that, heating was performed to volatilize ethanol, so that a mixed material was obtained.

Then, the mixed material was put in a crucible, and was fired at 1000° C. in the air for 10 hours at a flow rate of 10 L/min to synthesize the positive electrode active substance.

Subsequently, grinding was performed to separate the sintered particles that had been fired. After ethanol was added, grinding was performed using 0.5-mm-diameter beads in a bead mill for 10 hours at a peripheral speed of 4 m/s.

After the grinding, heating was performed to volatilize ethanol, and then, vacuum drying was performed. Through the above steps, a lithium-manganese composite oxide, which is a positive electrode active substance, was obtained.

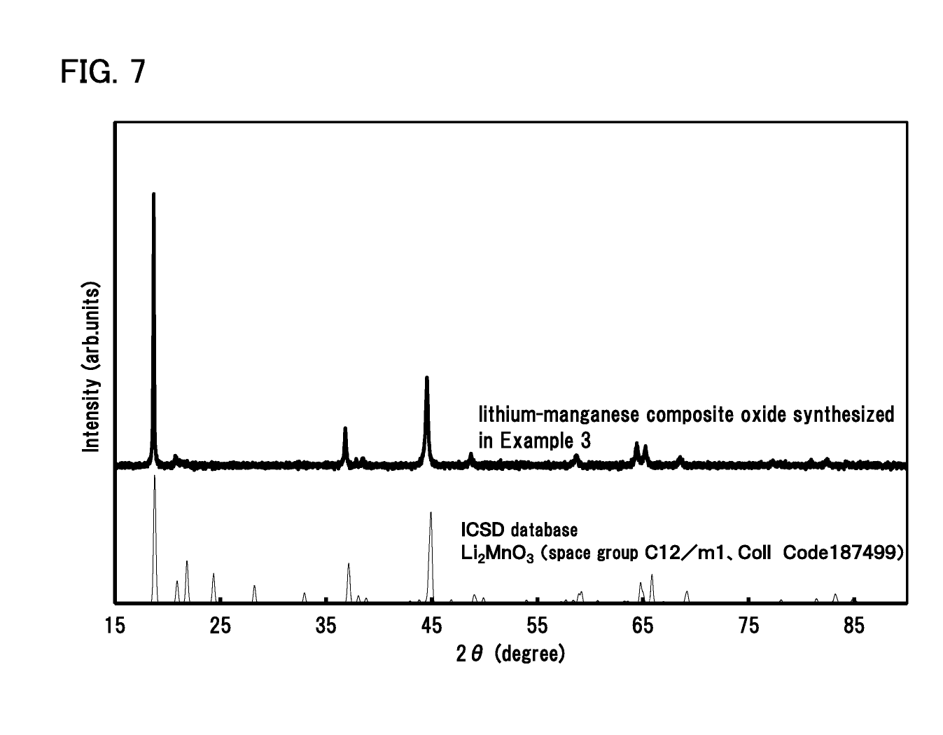

The lithium-manganese composite oxide fabricated as described above was subjected to X-ray diffraction (XRD) measurement. The measurement results are shown in FIG. 7. A main peak of the lithium-manganese composite oxide fabricated as described above, which is obtained by X-ray diffraction, approximately equals the peak of Li₂MnO₃ (space group C12/ml, Coll, Code187499) with a layered rock-salt structure, which is cited from the inorganic crystal structure database (ICSD).

A specific surface area of the lithium-manganese composite oxide fabricated as described above was measured with a micromeritics automatic surface area and porosimetry analyzer (TriStar II 3020 manufactured by SHIMADZU CORPORATION). The specific surface area was 10.4 m²/g.

### EXAMPLE 4

In this example, a half-cell was formed using the lithium-manganese composite oxide synthesized in Example 3, which was a positive electrode active substance, and the discharge characteristics were evaluated.

### [Fabrication of Electrode]

The positive electrode active substance fabricated in Example 1 was mixed with PVDF (polyvinylidene fluoride), acetylene black, and NMP (N-methyl-2-pyrrolidone) as a polar solvent, thereby forming a slurry.

Next, a current collector covered with an undercoat was prepared. The slurry was applied on the current collector covered with the undercoat and then dried. An electrode was stamped out from the sheet of the current collector.

### [Formation of Cell]

The fabricated electrode was used to form a half-cell. Metallic lithium was used for a counter electrode. The fabricated electrode was charged and discharged.

Note that an electrolytic solution was formed by dissolving LiPF₆ as a salt in a mixed solution containing ethylene carbonate and diethyl carbonate, which were aprotic organic solvents, at a volume ratio of 1:1. As the separator, polypropylene (PP) was used.

### [Discharge Characteristics Evaluation]

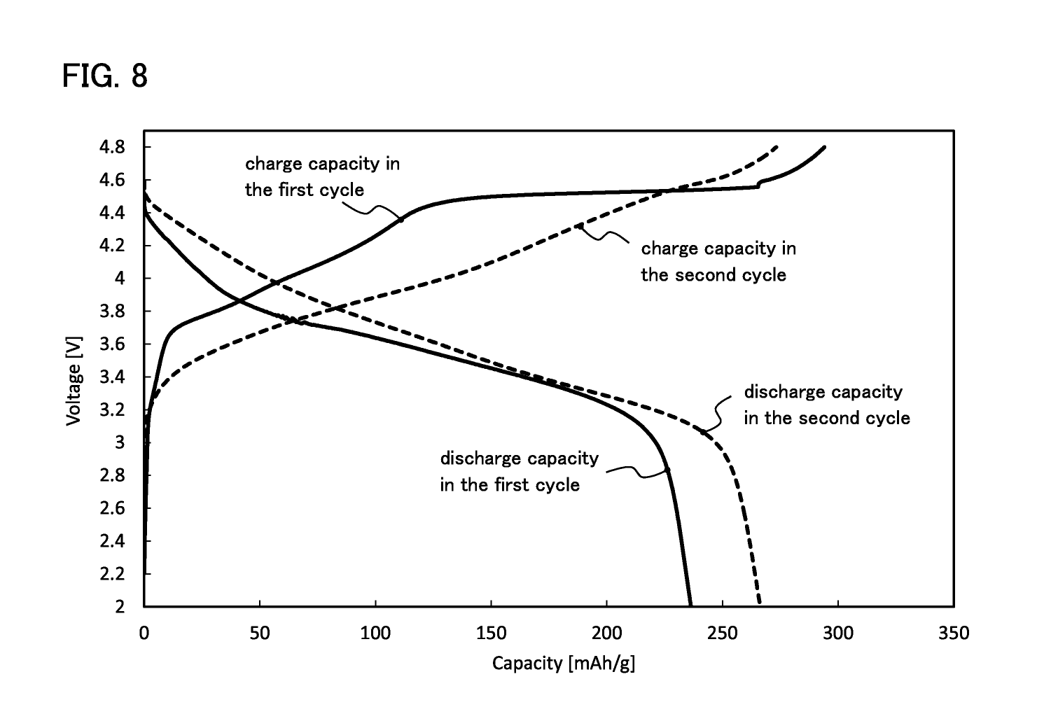

The charge capacity and discharge capacity of the fabricated half-cell were measured. The results are shown in FIG. 8. Charge was performed at a constant current with a current density of 30 mA/g until the voltage reached a termination voltage of 4.8 V. Discharge was performed at a constant current with a current density of 30 mA/g until the voltage reached a termination voltage of 2.0 V. The current density here represents a value per weight of a positive electrode active substance. The temperature during the charge and discharge measurements was 25° C. The charge capacity of the half-cell using the electrode was 294.1 mAh/g and the discharge capacity thereof was 236.4 mAh/g in the first cycle; the charge capacity thereof was 273.2 mAh/g and the discharge capacity thereof was 266.3 mAh/g in the second cycle; and the charge and discharge efficiency thereof in the first cycle was 80.38%.

### EXAMPLE 5

In this example, a secondary battery using the electrode fabricated in Example 1 as a negative electrode and the electrode fabricated in Example 3 as a positive electrode is described.

### [Fabrication of Coin Cell]

A coin cell was fabricated using the formed positive and negative electrodes. As the negative electrode to be combined with the lithium-manganese composite oxide, the electrode in which the compounding ratio of the carbon-based material (graphite) to the compound-based material containing oxygen and silicon was 90:10 was used. Since the initial charge and discharge efficiency of the positive electrode was 80.38%, the negative electrode whose initial charge and discharge efficiency was close to 80.38% was selected. The characteristics were measured with the use of a CR2032 coin cell (with a diameter of 20 mm and a height of 3.2 mm). For a separator, a stack of polypropylene and GF/C, which is Whatman (registered trademark) glass-fiber filter paper, was used. An electrolytic solution was formed in such a manner that lithium hexafluorophosphate (LiPF₆) was dissolved at a concentration of 1 mol/L in a mixed solution in which ethylene carbonate (EC) and diethyl carbonate (DEC) were mixed at a volume ratio of 3:7. A positive electrode can and a negative electrode can were formed of stainless steel (SUS).

Next, the fabricated coin cell was charged and discharged. The supported amount of the negative electrode used was set to 8 mg/cm², and the supported amount of the positive electrode used was set to 10 mg/cm². The measurement temperature was 25° C. The conditions for charge and discharge in the first cycle are as follows. The charge was performed in the following manner: constant current charge was performed at a rate of 0.03 C with the upper limit set to 4.6 V, and then, constant voltage discharge was performed at 4.6 V with the lower limit set to a current value corresponding to 0.01 C.

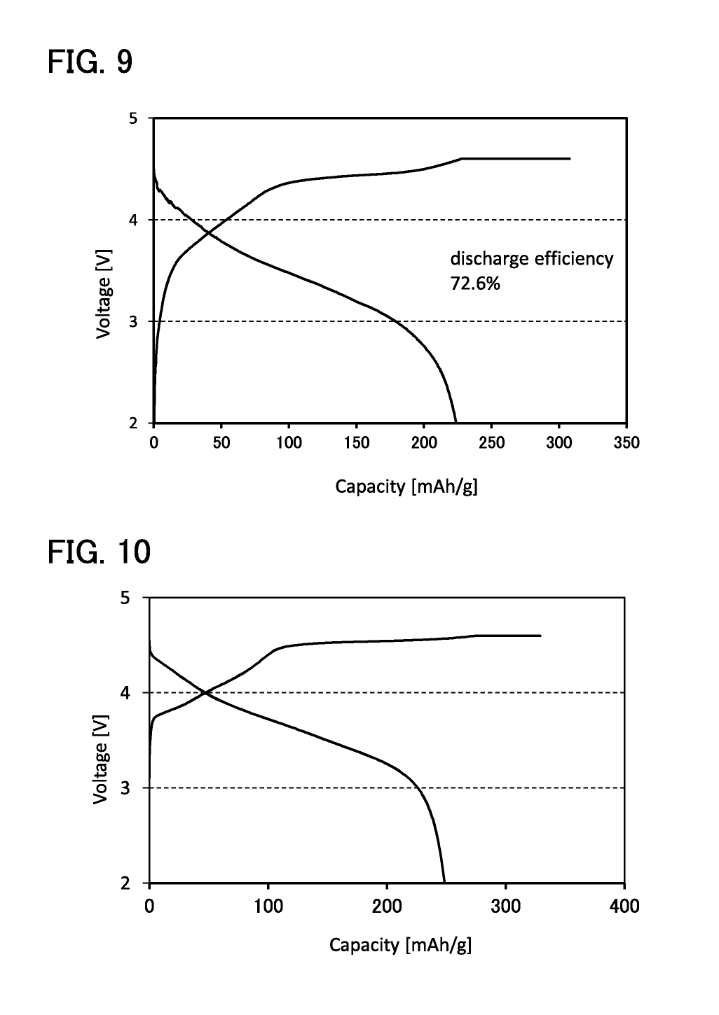

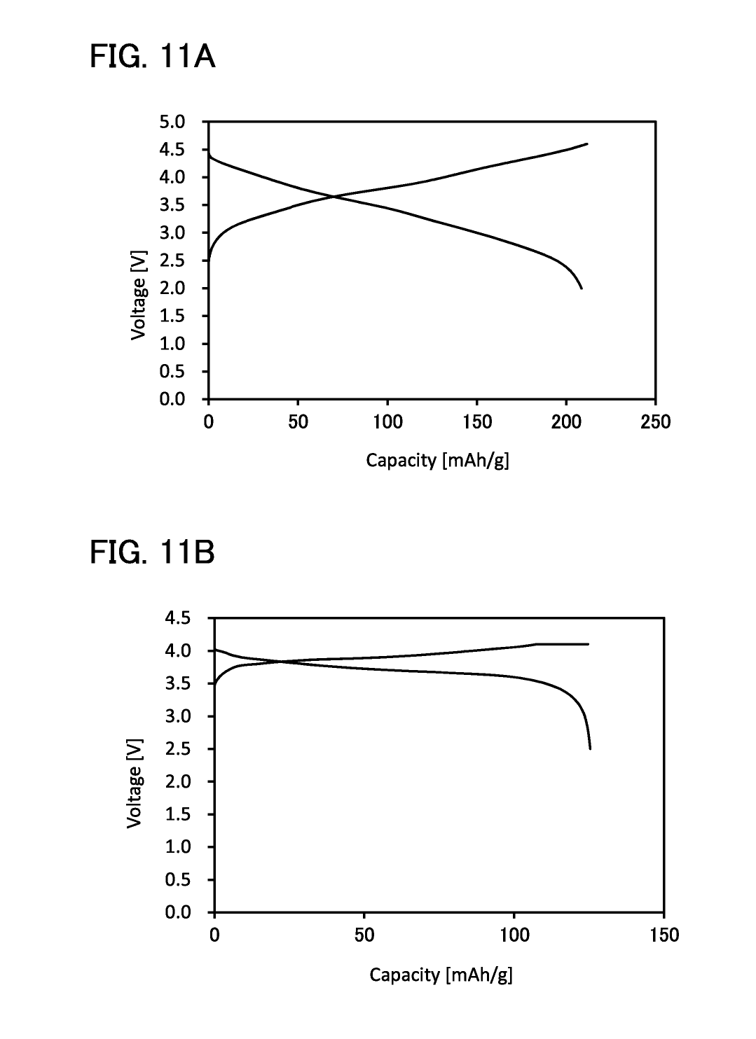

FIG. 9 shows charge and discharge curves in the first cycle and also the value of charge capacity with respect to discharge capacity as charge and discharge efficiency (charge capacity discharge capacity×100 [%]). As shown in FIG. 9, the initial charge and discharge efficiency is 72.6%, which is close to the charge and discharge efficiency of the half-cell of the lithium-manganese composite oxide in FIG. 10. This result reveals that the initial irreversible capacity of the lithium-manganese composite oxide was used as the initial irreversible capacity of the negative electrode active substance.

### [Fabrication of Storage Batteries]

Next, single-layer thin secondary batteries were fabricated using the formed positive and negative electrodes. As the negative electrode to be combined with the lithium-manganese composite oxide, the electrode in which the compounding ratio of a carbon-based material (graphite) to a compound-based material containing oxygen and silicon is 90:10 was used (cell A). As a comparison example, a thin secondary battery using an electrode using LiCoO₂ as a positive electrode active substance material and graphite as an active substance material of a negative electrode (not containing the compound-based material containing oxygen and silicon) to be combined with the positive electrode was also fabricated (cell B). An aluminum film covered with a heat sealing resin was used as an exterior body. The area of the positive electrode was 20.5 cm² and the area of the negative electrode was 23.8 cm². As the separator, 25-μm-thick polypropylene (PP) was used.

The electrolytic solution was formed in such a manner that an additive such as VC was added to a solvent mainly containing EC, DEC, and ethyl methyl carbonate (EMC). In the electrolyte solution, lithium hexafluorophosphate (LiPF₆) was dissolved at approximately 1.2 mol/L.

Next, the fabricated secondary batteries were subjected to aging. Note that rates were calculated using 240 mAh/g as a standard in the case of using the lithium-manganese composite oxide as the positive electrode (cell A) and 137 mAh/g as a standard in the case of using LiCoO₂ as the positive electrode (cell B). The cell A was charged to 10 mAh/g at 0.01 C at 25° C., and then degasification and resealing were performed. Subsequently, the cell was charged at 25° C. The charge was performed by CCCV, specifically, in such a manner that a voltage was applied at a constant current of 0.05 C until the voltage increased and reached 4.6 V and then a constant voltage of 4.6 V was maintained until the current value reached 0.01 C. After that, the cell was stored at 40° C. for 24 hours, and then degasification was performed again. The cell was discharged at 25° C. with the lower limit set to 2 V. After that, the cell was charged and discharged at 0.2 C twice. The cell B was charged to 10 mAh/g at 0.01 C at 25° C., and then degasification and resealing were performed. Subsequently, the cell was charged at 25° C. The charge was performed by CCCV, specifically, in such a manner that a voltage was applied at a constant current of 0.05 C until the voltage increased and reached 4.1 V and then a constant voltage of 4.1 V was maintained until the current value reached 0.01 C. After that, the cell was stored at 40° C. for 24 hours, discharged at 25° C. with the lower limit set to 2.5 V. After that, the cell was charged and discharged at 0.2 C twice.

Next, the cycle characteristics of the fabricated thin secondary batteries were measured. Initial charge and discharge were performed at a constant current of 0.2 C. In the case of the charge and discharge of the secondary battery using the lithium-manganese composite oxide as the positive electrode and the carbon-based material (graphite) and the compound-based material containing oxygen and silicon as the negative electrode, the upper voltage limit and the lower voltage limit were set to 4.6 V and 2 V, respectively. In the case of the charge and discharge of the secondary battery using LiCoO₂ as the positive electrode and graphite as the negative electrode, the upper voltage limit and the lower voltage limit were set to 4.1 V and 2.5 V, respectively. The measurement was performed at room temperature. FIGS. 11A and 11B each show charge and discharge curves in the first cycle.

The cell capacity of the secondary battery (cell A) using the lithium-manganese composite oxide as the positive electrode and the carbon-based material (graphite) and the compound-based material containing oxygen and silicon as the negative electrode was 126 mAh/g. In contrast, the cell capacity of the secondary battery for comparison (cell B) using LiCoO₂ as the positive electrode and graphite as the negative electrode was 78.2 mAh/g. In both of the positive electrode and the negative electrode used in the cell A, the active substance materials have high capacity and an initial charge and discharge efficiency of approximately 80%; thus, the electrodes have a problem of irreversible capacity. However, an increase in the total mass of the active substance materials was suppressed by using the effect of canceling irreversible capacity. Consequently, the active substance materials in the secondary battery successfully showed high battery capacity per unit mass compared to the secondary battery for comparison (cell B). Note that the capacity, charge and discharge efficiency, compounding proportions of the two active substance materials of the negative electrode roughly satisfy the equation (4) in Embodiment 1.

This application is based on Japanese Patent Application serial no. 2014-045546 filed with the Japan Patent Office on Mar. 7, 2014, the entire contents of which are hereby incorporated by reference.

What is claimed is:

1. A secondary battery comprising:
a first electrode comprising a first electrode active substance; and
a second electrode comprising a second electrode active substance and a third electrode active substance,
wherein charge and discharge efficiency of the second electrode active substance is different from charge and discharge efficiency of the third electrode active substance.

2. The secondary battery according to claim 1, wherein the first electrode is a positive electrode and the second electrode is a negative electrode.

3. The secondary battery according to claim 1, wherein the second electrode active substance comprises carbon.

4. The secondary battery according to claim 1, wherein the third electrode active substance comprises silicon and oxygen.

5. The secondary battery according to claim 1, wherein the first electrode active substance comprises lithium.

6. The secondary battery according to claim 1, wherein the secondary battery is a flexible lithium-ion secondary battery.

7. A secondary battery comprising:
a first electrode comprising a first electrode active substance; and
a second electrode comprising a second electrode active substance and a third electrode active substance,
wherein the second electrode active substance has higher charge and discharge efficiency than the first electrode active substance, and
wherein the third electrode active substance has lower charge and discharge efficiency than the second electrode active substance.

8. The secondary battery according to claim 7,
wherein a product of capacity of the second electrode active substance and a difference between charge and discharge efficiency of the second electrode active substance and charge and discharge efficiency of the first electrode active substance is greater than a product of capacity of the third electrode active substance and a difference between the charge and discharge efficiency of the first electrode active substance and charge and discharge efficiency of the third electrode active substance, and
wherein a compounding proportion of the second electrode active substance in a total of the second electrode active substance and the third electrode active substance is less than a compounding proportion of the third electrode active substance in the total of the second electrode active substance and the third electrode active substance.

9. The secondary battery according to claim 7,
wherein a product of capacity of the second electrode active substance and a difference between charge and discharge efficiency of the second electrode active substance and charge and discharge efficiency of the first electrode active substance is less than a product of capacity of the third electrode active substance and a difference between the charge and discharge efficiency of the first electrode active substance and charge and discharge efficiency of the third electrode active substance, and
wherein a compounding proportion of the second electrode active substance in a total of the second electrode active substance and the third electrode active substance is greater than a compounding proportion of the third electrode active substance in the total of the second electrode active substance and the third electrode active substance.

10. The secondary battery according to claim 7, wherein the first electrode is a positive electrode and the second electrode is a negative electrode.

11. The secondary battery according to claim 7, wherein the second electrode active substance comprises carbon.

12. The secondary battery according to claim 7, wherein the third electrode active substance comprises silicon and oxygen.

13. The secondary battery according to claim 7, wherein the first electrode active substance comprises lithium.

14. The secondary battery according to claim 7, wherein the secondary battery is a flexible lithium-ion secondary battery.

15. A secondary battery comprising:
a first electrode comprising a first electrode active substance; and
a second electrode comprising a second electrode active substance and a third electrode active substance,
wherein a compounding proportion of the second electrode active substance in a total of the second electrode active substance and the third electrode active substance satisfies an equation (1), and
$${R}_{2} = \frac{{Q}_{3} ( {E}_{1} - {E}_{3} )}{{Q}_{2} ( {E}_{2} - {E}_{1} ) + {Q}_{3} ( {E}_{1} - {E}_{3} )} \qquad ( 1 )$$
wherein in the equation (1):
R₂ represents the compounding proportion of the second electrode active substance;
E₁ represents charge and discharge efficiency of the first electrode active substance;
Q₂ represents capacity of the second electrode active substance;
E₂ represents charge and discharge efficiency of the second electrode active substance;
Q₃ represents capacity of the third electrode active substance; and
E₃ represents charge and discharge efficiency of the third electrode active substance.

16. The secondary battery according to claim 15, wherein the first electrode is a positive electrode and the second electrode is a negative electrode.

17. The secondary battery according to claim 15, wherein the second electrode active substance comprises carbon.

18. The secondary battery according to claim 15, wherein the third electrode active substance comprises silicon and oxygen.

19. The secondary battery according to claim 15, wherein the first electrode active substance comprises lithium.

20. The secondary battery according to claim 15, wherein the secondary battery is a flexible lithium-ion secondary battery.
